(19) United States
(12) Patent Application Publication
(10) Pub. No.: US 2026/0336073 A1
(43) Pub. Date: Oct. 29, 2026

(54) FASTENER FEEDING SYSTEM WITH LANE INTERCHANGER

(71) Applicant: Spirit AeroSystems, Inc., Wichita, KS (US)

(72) Inventor: John R. Dye, Wichita, KS (US)

(21) Appl. No.: 19/188,258

(22) Filed: Apr. 24, 2025

(51) Int. Cl. B25B 23/04

(52) U.S. Cl. CPC B25B 23/04

(57) ABSTRACT

A fastener feeding system employs a lane interchanger system to selectively feed a plurality of fastener types to a plurality of fastener installation guns. The lane interchanger system uses a first lane changer, a second lane changer, and lane change tube connecting the two lane changers. The first lane changer is configured to selectively connect the lane change tube to various fastener staging lanes, and the second lane changer configured to selectively connect the second end of the lane change tube to various gun lanes. The lane interchanger system thereby connects a chosen fastener staging lane to a chosen gun lane so a fastener of a specified type is deliverable through the lane interchanger system to any fastener installation gun on request.

### FIELD

This disclosure generally pertains to fastener feeding system for selectively feeding any of a plurality of different types of fasteners to one or more fastener installation guns.

### BACKGROUND

US Patent Application Publication No. 2021/0187676 and US Patent Application Publication No. 2022/0161315 describe systems and methods for drilling holes and installing fasteners in vehicle structures, e.g., aerostructures such as aircraft fuselages. The systems are used to reduce human errors when installing fasteners in a location or application that is not well-suited for complete automation.

The system employs one or more drill plates with preformed template holes that correspond to a specified pattern of fasteners for a particular location on a vehicle structure. Each drill plate is equipped with machine readable elements (e.g., RFID tags) associated with each of the template holes. The machine readable elements present information about the type of hole and fastener required at the corresponding location on the vehicle structure. The drill plates releasably attach to the vehicle structure at specified locations so that specified fastener holes of different types can be drilled through the template holes and/or specified fasteners of different types can be installed through the template holes at the specified locations.

Smart drill guns are configured to mate with each template hole and drill the correct fastener hole at each template hole locations. Each smart drill gun is equipped with a reader for reading the machine readable element associated with the template hole to which it is mated. During use, a human operator mates each smart drill gun to the respective template hole and then the gun automatically reads the respective machine readable element to determine the required characteristics for the fastener hole. A controller associated with the smart drill gun then determines whether the drill is properly configured for drilling the required fastener hole. Then if the drill gun is properly configured for drilling the required hole, the controller automatically conducts the necessary drilling operation to form a fastener hole of the specified depth and diameter. But if the drill gun is not properly configured (e.g., the wrong size drill bit is installed), the drill gun controller will automatically prevent the user from drilling a wrong-sized fastener hole at the template hole location.

Smart fastener installation guns are also configured to mate with each template hole for installing fasteners in the pre-drilled fastener holes. Like the smart drill guns, each smart fastener installation gun is equipped with a reader that can read the machine readable elements on the drill plates. The smart fastener gun is connected by a tube to a fastener feeding system that is configured to feed selected fasteners to one or more smart fastener installation guns upon request. During use, a human operator mates the smart fastener installation gun to the respective template hole and then the gun automatically reads the respective machine readable element to determine what type of fastener needs to be installed. The smart fastener installation gun then sends a signal to the fastener feeding system, and the fastener feeding system automatically delivers the correct type of fastener to the requester fastener installation gun.

This disclosure primarily pertains to new systems and components for the fastener feeding system that feeds any of a plurality of different types of fasteners to a requester fastener installation gun on demand. The inventors recognized that there was opportunity to improve upon the fastener feeding system described in US Patent Application Publication No. 2021/0187676 and US Patent Application Publication No. 2022/0161315, e.g., by enabling more fastener installation guns to be fed by the same fastener feeding system, enabling fasteners to be fed to the fastener installation gun more quickly, and/or enabling more reliable delivery of fasteners from the fastener feeding system to each fastener installation gun.

### SUMMARY

In one aspect, a fastener feeding system for selectively feeding a plurality of fastener types to a plurality of fastener installation guns comprises a plurality of fastener staging lanes and a plurality of gun lanes. Each fastener staging lane comprises a passage configured for receiving a plurality of fasteners of one of the plurality of fastener types. Each gun lane defines a passage having a proximal end portion and a distal end portion configured to operatively connect to one of the plurality of fastener installation guns. The passage of each gun lane is sized and arranged such that fasteners of any of the plurality of fastener types are deliverable through the passage from the proximal end portion to the distal end portion to the respective fastener installation gun. A lane interchanger system comprises a first lane changer, a second lane changer, and lane change tube having a first end and a second end. The first lane changer is configured to selectively connect the first end of the lane change tube to any of the fastener staging lanes. The second lane changer configured to selectively connect the second end of the lane change tube to any of the gun lanes. A controller is configured to receive a request for a fastener of a specified fastener type from one of the fastener installation guns. In response to receiving the request, the controller is configured to adjust the first lane changer to selectively connect the first end of the lane change tube to the fastener staging lane containing the specified fastener type and adjust the second lane changer to connect the second end of the lane change tube to the gun lane operatively connected to said one of the fastener installation guns, whereby the lane change tube operatively connects said fastener staging lane containing the specified fastener type to said gun lane operatively connected said one of the fastener installation guns so that said fastener of the specified type is deliverable through the lane interchanger system to said one of the fastener installation guns.

In another aspect, a lane interchanger system for selectively delivering fasteners from fastener staging lanes of a fastener feeding system to gun lanes of the fastener feeding system comprises a first lane changer comprising a first lane changer manifold defining a plurality of first lane changer orifices spaced apart circumferentially about a first axis of rotation. Each first lane changer orifice is configured to connect to a respective fastener staging lane. The first lane changer further comprises a first lane changer arm and a first lane changer driver configured to selectively rotate the first lane changer arm about the first axis of rotation to operatively align the first lane changer arm with each of the plurality of first lane changer openings. A second lane changer comprises a second lane changer manifold defining a plurality of second lane changer orifices spaced apart circumferentially about a second axis of rotation. Each second lane changer orifice is configured to connect to a respective gun lane. The second lane changer further comprises a second lane changer arm and a second lane changer driver configured to selectively rotate the second lane changer arm about the second axis of rotation to operatively align the second lane changer arm with each of the plurality of second lane changer openings. A lane change tube has a first end and a second end. The first end is coupled to the first lane changer arm for movement with first lane changer arm about the first axis of rotation such that when the first lane changer arm is operatively aligned with one of the first lane changer openings the first end of the lane change tube is positioned for receiving a fastener delivered from the respective fastener staging lane. The second end is coupled to the second lane changer arm such that when the second lane changer arm is operatively aligned with one of the second lane changer openings the second end of the lane change tube is positioned for delivering a fastener to the respective gun lane.

In another aspect, a method of installing fasteners in a vehicle structure comprises receiving a request for a first fastener of a first fastener type from a fastener installation gun. In response to receiving the request, a first lane changer is actuated to adjust a first end of a lane change tube to be in communication with a fastener staging lane containing fasteners of the first fastener type. Further in response to receiving the request, a second lane changer is actuated to adjust the second end of the lane change tube to be in communication with a gun lane connected to said fastener installation gun. After actuating the first and second lane changers, a first fastener from the fastener staging lane is delivered through the lane change tube and through said gun lane to said fastener installation gun. The first fastener is installed using said fastener installation gun.

In another aspect, a fastener feeding system for selectively feeding a plurality of fastener types to a plurality of fastener installation guns comprises a plurality of fastener staging lanes and a plurality of gun lanes. Each fastener staging lane comprises a passage configured for receiving a plurality of fasteners of one of the plurality of fastener types. A plurality of gun lanes, each gun lane defines a passage having a proximal end portion and a distal end portion configured to operatively connect to one of the plurality of fastener installation guns. A lane interchanger system is configured to selectively connect each fastener staging lane to any of the fastener gun lanes such that a fastener from a selected fastener staging lane is deliverable through the lane interchanger system to a selected gun lane whereby a fastener is deliverable from the selected fastener lane to the fastener installation gun connected to the selected gun lane. Each fastener escapement apparatus among a plurality of fastener escapement apparatuses connects a respective one of the fastener staging lanes to the lane interchanger system and is configured to be selectively actuated to deliver fasteners one-at-a-time from the respective one of the fastener staging lanes to the lane interchanger system. A controller is configured to receive a request for a fastener of a specified fastener type from one of the fastener installation guns. In response to receiving the request, the controller is configured to adjust the lane interchanger system to connect the fastener staging lane for the specified fastener type to the gun lane connected to said one of the fastener installation guns and to actuate the fastener escapement apparatus connecting said fastener staging lane for the specified fastener type to deliver one fastener of the specified type to the lane interchanger system.

In another aspect, a fastener escapement apparatus for a fastener feeding system comprises a chassis configured to be mounted on a lane interchanger system of the fastener feeding system. A fastener cartridge is supported on the chassis. The fastener cartridge comprises a cartridge body having an upstream end portion, a downstream end portion, and a fastener passage extending along an axis from the upstream end portion through the downstream end portion. The upstream end portion is configured to connect to a fastener staging lane of the fastener feeding system such that fasteners from the fastener staging lane are deliverable into the fastener passage through the upstream end portion. The downstream end portion of the fastener cartridge is configured to operatively couple to the lane interchanger system when the chassis is mounted on the lane interchanger system such that fasteners are deliverable from the fastener passage to the lane interchanger system through the downstream end portion. An escapement actuator is supported on the chassis and operably coupled to the fastener cartridge between the upstream end portion and the downstream end portion. The escapement actuator is configured to be selectively actuated to deliver fasteners one-at-a-time from the fastener passage to the lane interchanger system.

In another aspect, a fastener escapement apparatus for a fastener feeding system comprises a chassis configured to be mounted on a lane interchanger system of the fastener feeding system. A pneumatic escapement actuator supported on the chassis is configured to advance fasteners from a fastener staging lane one-at-a-time to the lane interchanger system. A solenoid valve is supported on the chassis and is pneumatically connected to the pneumatic escapement actuator for selectively actuating the pneumatic escapement actuator. A local controller is supported on the chassis and is configured for receiving input from a main controller of the fastener feeding system and controlling the solenoid valve in response to the input. A single power input is supported on the chassis and is configured for connecting the fastener escapement apparatus to a main power source. A single controller input is supported on the chassis and is configured for connecting the fastener escapement apparatus to the main controller. Daisy chain ports are supported on the chassis and configured for connecting the fastener escapement apparatus to at least one other fastener escapement apparatus in a daisy chain.

In another aspect, a fastener feeding system for selectively feeding a plurality of fastener types to a fastener installation gun comprises a plurality of fastener staging lanes. Each fastener staging lane comprises a passage configured for receiving a plurality of fasteners of one of the plurality of fastener types. A gun lane defines a passage having a proximal end portion and a distal end portion operatively connected to the fastener installation gun. A lane interchanger system is configured to selectively connect each fastener staging lane to the gun lane. The lane interchanger system comprises a lane changer. The lane changer comprises an arm including a fastener guide. The fastener guide defines a fastener lumen through which a fastener of any of the plurality of fastener types is passable from one of the fastener staging lanes to the gun lane. A driver is configured to move the arm to selectively connect the fastener lumen to any of the plurality of fastener staging lanes. The arm comprises an integrated air booster configured to impart pressurized air into the fastener lumen when a fastener is delivered through the fastener lumen to boost the fastener toward the fastener installation gun. A controller is configured to receive a request for a fastener of a specified fastener type from the fastener installation gun, and in response to the request, to actuate the driver to move the arm to connect the fastener lumen to the fastener staging lane for the fastener of the specified fastener type so that a fastener from said fastener staging lane is deliverable through the lane interchanger system to the fastener installation gun.

In another aspect, an arm for a lane changer of a fastener feeding system comprises an arm body having an inner end portion and an outer end portion spaced apart along an arm axis oriented radially with respect to an axis of rotation of the lane changer. The inner end portion of the arm body is configured to connect to a driver of the lane changer such that the driver can rotate the arm body about the axis of rotation. The outer end portion of the arm body defines a receiver and an air passage having a first end opening into the receiver and a second end opening externally to the arm body. A sleeve is received in the receiver and has an interior. The sleeve has an opening in fluid communication with the air passage and the interior of the sleeve. A fastener guide is received in the interior of the sleeve such that the fastener guide and the sleeve define an annular booster cavity therebetween. The annular booster cavity is in fluid communication with the opening in the sleeve. The fastener guide defines a fastener lumen through which a fastener is passable from a fastener staging lane to a gun lane of the fastener feeding system. The fastener guide further defines a booster lumen providing fluid communication between the annular booster cavity and the fastener lumen. The air passage, the opening, the annular booster cavity, and the booster lumen form an integrated air booster configured to impart pressurized air into the fastener lumen when a fastener is delivered through the fastener lumen to boost the fastener toward a fastener installation gun.

In another embodiment, a fitting assembly for a fastener feeding system comprises a main body defining a receiver and an air passage having a first end opening into the receiver and a second end opening externally to the main body. A sleeve is received in the receiver and has an interior. The sleeve has an opening in fluid communication with the air passage and the interior of the sleeve. A fastener guide is received in the interior of the sleeve such that the fastener guide and the sleeve define an annular booster cavity therebetween. The annular booster cavity is in fluid communication with the opening in the sleeve. The fastener guide defines a fastener lumen through which a fastener is passable to a fastener installation gun. The fastener guide further defines a booster lumen providing fluid communication between the annular booster cavity and the fastener lumen. The booster lumen is skewed with respect to the fastener lumen. The air passage, the opening, the annular booster cavity, and the booster lumen form an integrated air booster configured so that pressurized air imparted into the air passage is delivered from the air passage through the opening in the sleeve into the annular booster cavity, and from the annular booster cavity through the booster lumen into the fastener lumen at an angle such that the pressurized air in the fastener lumen boosts the fastener in the downstream direction.

Other aspects will be in part apparent and in part pointed out hereinafter.

### BRIEF DESCRIPTION OF THE DRAWINGS

FIG. 1 is a schematic illustration of a system for drilling holes and installing fasteners in vehicle structures;

FIG. 1A is a schematic block diagram of a control system for the system of FIG. 1;

FIG. 2 is a perspective of a fastener feeding system of the system of FIG. 1;

FIG. 2A is another perspective of the fastener feeding system;

FIG. 2B is an enlarged view of a portion of FIG. 2A;

FIG. 2C is a schematic illustration of a fastener intake system, a fastener sorting system, and a fastener staging system of the fastener feeding system;

FIG. 2D is a flow chart for a process fastener intake via the fastener feeding system;

FIG. 3 is a schematic illustration of a lane interchanger system of the fastener feeding system;

FIG. 4 is a perspective of an exemplary embodiment of the lane interchanger system;

FIG. 5 is a perspective of a first lane changer of the lane interchanger system with a single fastener escapement apparatus mounted thereon and additional fastener escapement apparatuses removed to better show components of the first lane changer;

FIG. 6 is an elevation of the first lane changer;

FIG. 7 is a perspective of the first lane changer;

FIG. 8 is a plan view of the first lane changer;

FIG. 9 is a perspective of a fastener escapement apparatus;

FIG. 9A is another perspective of the fastener escapement apparatus;

FIG. 10 is an elevation of the fastener escapement apparatus with an electronics cover removed to reveal electronics contained in an electronics enclosure of the fastener escapement apparatus;

FIG. 11 is a perspective of a subassembly of the fastener escapement apparatus including an interchangeable fastener cartridge and an escapement actuator;

FIG. 11A is a perspective of the escapement actuator;

FIG. 12 is a cross-sectional perspective of the subassembly of FIG. 11;

FIGS. 12A-E are a series of cross sections of the fastener escapement apparatus depicting a single-fastener discharge routine;

FIG. 13 is a cross section of the subassembly of FIG. 11;

FIG. 14 is a perspective of a lane changer arm of the first lane changer;

FIG. 15 is a plan view of the lane changer arm;

FIG. 16 is a cross section taken in the plane of line 16-16 of FIG. 15;

FIG. 17 is a cross section taken in the plane of line 17-17 of FIG. 15;

FIG. 18 is a perspective of a fastener guide of the lane changer arm; and

FIG. 19 is a flow chart of an automated process for using the lane interchanger system to deliver a fastener of one of a plurality of different fastener types to one of a plurality of fastener installation guns upon request.

Corresponding parts are given corresponding reference characters throughout the drawings.

### DETAILED DESCRIPTION

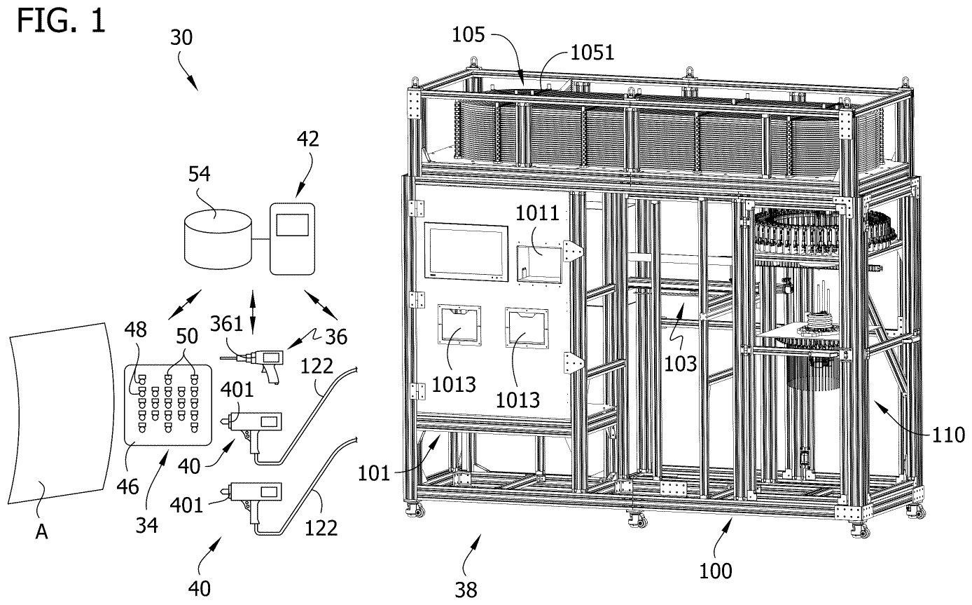

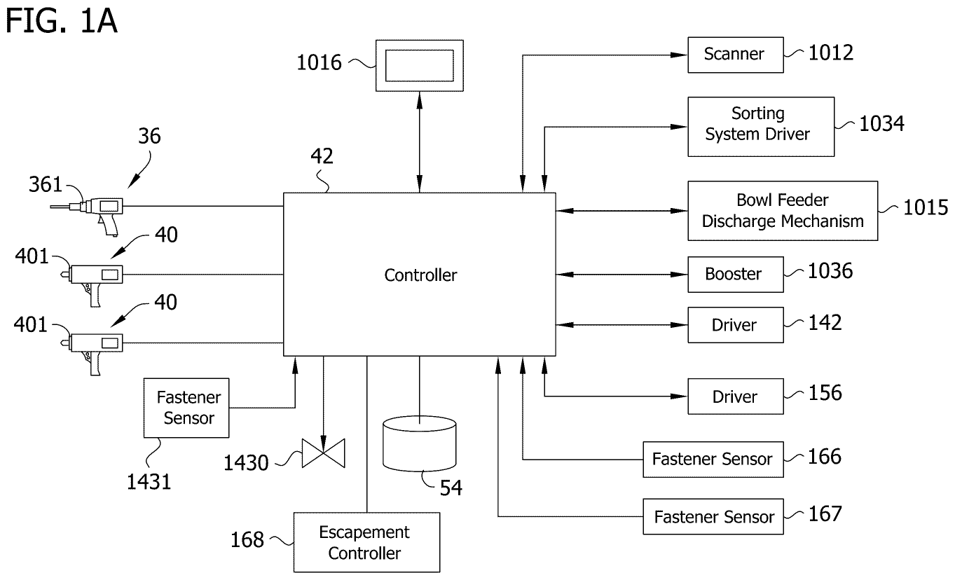

Referring to FIGS. 1 and 1A, an exemplary embodiment of a semi-autonomous system for drilling holes and installing fasteners in vehicle structures (e.g., an aerostructure shown schematically at reference A) is generally indicated at reference number 30. As described in US Patent Application Publication No. 2021/0187676 and US Patent Application Publication No. 2022/0161315, the system 30 is broadly configured to drill holes and/or deliver, seal, insert, and otherwise install fasteners in a structure A. The illustrated system 30 includes one or more drill plates 34, one or more drill guns 36, a fastener feeding system 38, a plurality of fastener installation guns 40, and a system controller 42.

Each drill plate 34 is configured to temporarily attach to or otherwise physically position on the structure A and inform and physically guide the operation of the drill gun 36 in drilling the holes in the structure and inform and physically guide the operation of the fastener installation guns 40 in installing the fasteners in the structure. In one implementation, each drill plate 34 may include a plate body 46, one or more openings 48 through which the holes are drilled and the fasteners are installed, and one or more machine-readable elements 50 associated with the openings 48. The openings 48 are arranged on the plate body 46 to correspond with specified fastener positions on the structure A. That is, the openings 48 define a fastener template for indicating and guiding operation of the drill gun 36 and fastener installation gun 40 so that holes are drilled and fasteners are installed in the specified locations.

The one or more machine-readable elements 50 may be configured to store and communicate information relevant to drilling the holes and installing the fasteners. Such information may include a size of a drill bit; a speed of the drill; a type, size, or grip length of a fastener; a drill feed by stack material; whether coolant should be used; a hammer time; and whether sealant should be applied. The machine-readable elements 50 may employ substantially any suitable machine-readable technology. Although generally described herein as being radio-frequency identification (RFID) elements, the machine-readable elements 50 may alternatively be, for example, readable barcodes or quick response (QR) codes.

The drill guns 36 and the fastener installation guns 40 include reader mechanisms 361, 401 (e.g., an RFID reader or an optical sensor for recognizing a QR code) configured to read the information stored on the machine-readable elements 50. The system 30 uses the information the reader mechanisms read from the machine-readable elements 50 to ensure that the drilling and installation processes are performed without error. In one implementation, the information may be stored on the machine-readable element 50, while in another implementation, the information may be stored in an electronic memory element 54 and the machine-readable element 50 may provide an identification code (e.g., a twenty-four-bit alphanumeric identifier) which can be used to electronically access the information from the electronic memory element 54. In one implementation, the system 30 may be further configured to determine, through electronic based on information read from the machine-readable element 50 and information stored in system memory 54, whether a hole has been drilled and whether a fastener has been installed through the respective opening 48. The controller 42 is configured to control operation of the drill guns 36 and fastener installation guns 40 based on this information.

The fastener feeding system 38 is broadly configured to receive, sort, store, track, and deliver the fasteners to the fastener insertion guns 40 so that the fastener installation guns install the specified type of fastener after mating with an opening 48 and reading the machine-readable element. In one implementation, the fastener feeding system 38 is configured to manage and supply fasteners of a plurality of different fastener types (e.g., diameters and/or grip lengths) to the fastener insertion guns 40 upon request.

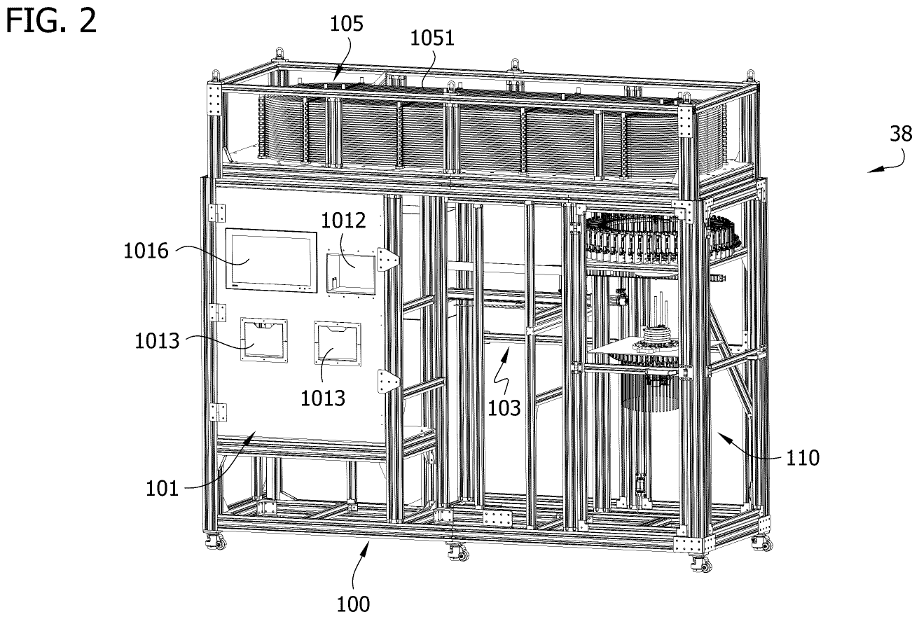

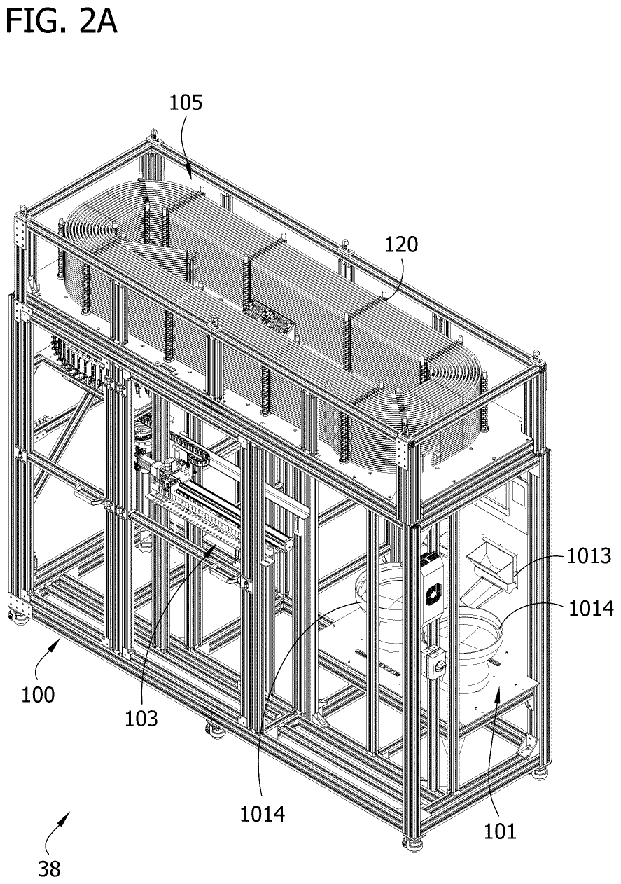

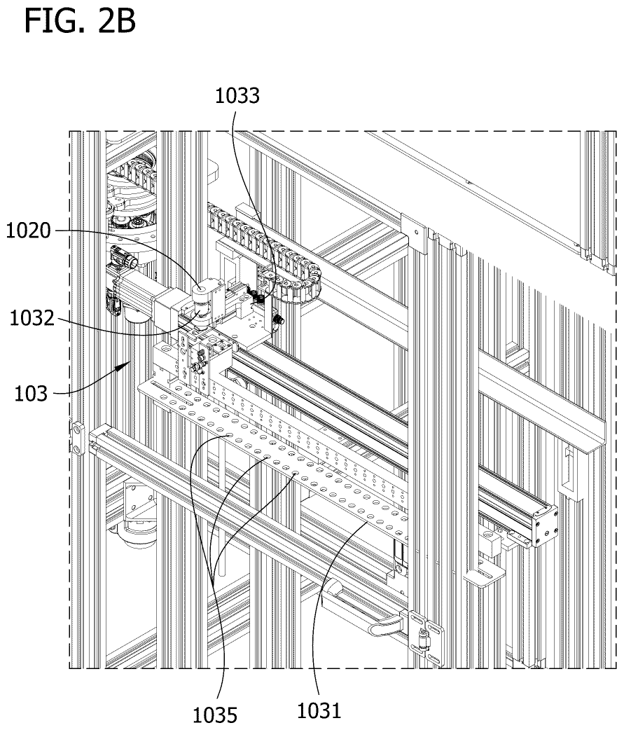

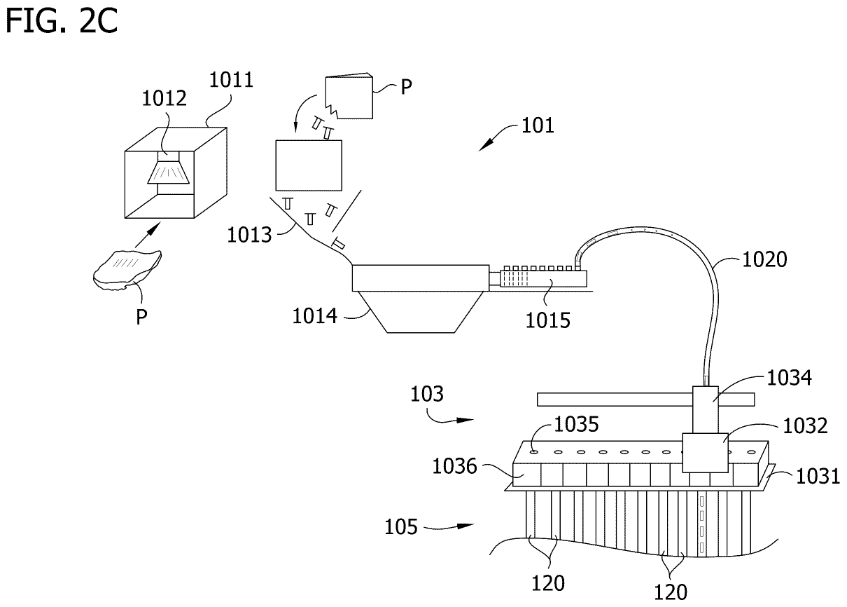

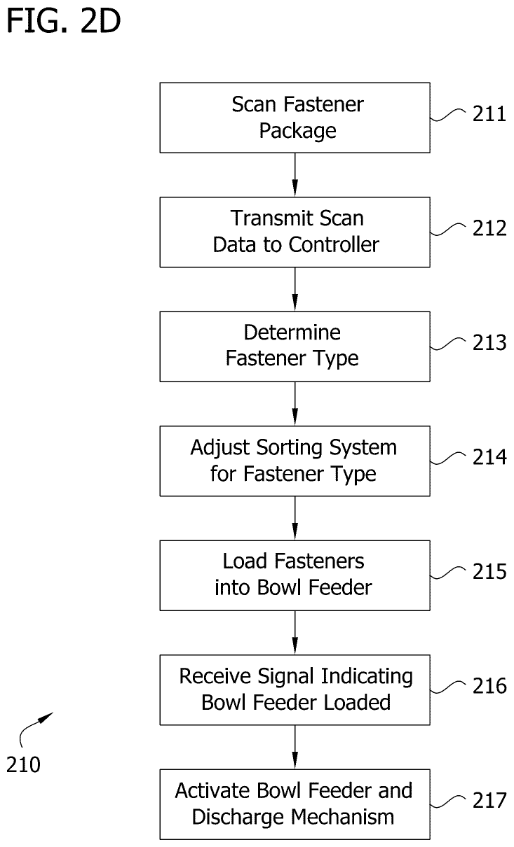

Referring to FIGS. 2A-2C, the illustrated fastener feeding system 38 comprises a cabinet 100 that supports a fastener intake system 101, a fastener sorting system 103, a fastener staging system 105, and a lane interchanger system 110. In general, the fastener intake system 101 is configured to identify fasteners input into the system, organize loose fasteners into single-file rows, and provide an organized stream of the identified fasteners to the fastener sorting system 103. The fastener sorting system 103 is broadly configured to receive the stream of identified fasteners from the fastener intake system 101, connect it to a correct fastener staging lane 120 of the fastener staging system 105, and deliver the fasteners from the fastener intake system into the correct fastener staging lane. The fastener staging system 105 includes fastener staging lanes 120 stored in a compact way so that many fasteners of each fastener type are staged and ready for use by a fastener installation gun 40 at a moment's notice. The lane interchanger system 110 is broadly configured to connect any of the plurality of staging lanes 130 to any of the fastener installation guns 40 on demand so that a fastener of any requested fastener type can be delivered to the fastener installation gun in less than 2 seconds. The lane interchanger system 110 is a major focus of this disclosure. But first, to provide a better understanding of how the lane interchanger system 110 interacts with the fastener feeding system 38 as a whole, the fastener intake system 101, fastener sorting system 103, and fastener staging system 105 are briefly described below.

The illustrated fastener intake system 101 comprises a scanning module 1011 comprising a scanner 1012 (shown schematically in FIG. 2C) configured to scan an optically readable code (broadly, a machine-readable element) on a pre-marked fastener package P (FIG. 2C) to determine what type of fasteners are contained in the fastener package. The scanner 1012 communicates with the controller 42 to indicate the fasteners that are being input into the system.

The fastener intake system 101 further comprises a pair of fastener chutes 1013 (only one is shown schematically in FIG. 2C) through which fasteners from a scanned fastener package P can be delivered to a respective bowl feeder 1014, shown in FIG. 2A. The bowl feeders 1014 are configured to receive loose fasteners poured in through chutes 1013 and organize them into a single file rows of upright fasteners arranged side-by-side. The bowl feeders 1014 connect to a feeding mechanism 1015 (FIG. 2C) that can deliver the pre-organized fasteners one-at-a-time through a delivery tube 1020 connected to the fastener sorting system 103.

In the illustrated embodiment, the fastener intake system 101 further comprises a user interface device 1016 (FIG. 2) in communication with the controller 42 (see FIG. 1A). In one or more embodiments, the user interface device 1016 is a touch screen display permitting the user to make selections and control inputs. For example, in certain embodiments, a user can use the user interface device 1016 to activate the bowl feeder via the controller 42. In other embodiments, the bowl feeders 1014 are activated automatically, e.g., when the door of a chute 1013 is opened or when fasteners are detected on the bowl feeder.

Referring to FIG. 2B and FIG. 2C, the fastener sorting system 103 comprises a sorting manifold rail 1031 configured to connect to each of the fastener staging lanes 120, a fastener discharge fitting 1032, a driver 1034 configured to drive the fastener discharge fitting along the fastener manifold rail, and a plurality of boosters 1036 configured for advancing fasteners along respective staging lanes on command. The fastener manifold rail 1031 has a length and a plurality of fastener orifices 1035 spaced apart along the length. Each fastener orifice 1035 couples to the upstream end of respective fastener staging lane 120. The controller 42 is configured to receive information from the scanner 1012 about the type of fastener loaded into the bowl feeder 1014, and in response, signal the sorting system driver 1034 to position the fastener discharge fitting 1032 in line with the orifice 1035 for the respective fastener staging lane 120.

Thus, each time a new package P of fasteners is loaded into the fastener feeding system 38, a process 210 depicted in FIG. 2D is conducted via a mix of manual steps and automated processes conducted by the controller 42. At step 211, the user scans the fastener package P using the scanner 1012. At step 212, the scanner 1012 then signals the controller 42 with the data obtained. At step 213, the controller determines the type of fastener contained in the package. At step 214, the controller 42 signals the sorting system driver 1034 to drive the fastener discharge fitting 1032 to align with the fastener orifice 1035 corresponding to the fastener staging lane 120 containing the type of fasteners identified in the scan conducted in steps 211 and 212. At step 215, the user loads the loose fasteners from the scanned package onto the bowl feeder 1014 through the chute 1013. At step 216, the controller receives a signal (either from user input to the interface 1016 or a fastener sensor (not shown) associated with the bowl feeder 1014) to activate the bowl feeder. In response, at step 217, the controller 42 activates the bowl feeder and controls the bowl feeder discharge mechanism to deliver fasteners one-at-a-time through the delivery tube 1020. The fasteners flow through the delivery tube 1020 arranged end-to-end in a single stream, then through the discharge fitting 1032 into the correct fastener staging lanes.

Referring to FIG. 2, each fastener staging lane 120 is a flexible tube configured to hold a single file row of fasteners arranged end-to-end along the length of the tube. Each fastener staging lane 120 comprises an upstream end connected to a respective orifice 1035 of the sorting manifold rail, as described above. Each fastener staging lane 120 has a length extending from the upstream end to a downstream end portion that is connected to the lane interchanger system 110, as described in further detail below.

The illustrated fastener staging system 105 includes tube supports 1051 mounted on an upper portion of the cabinet 100. The fastener staging lanes 120 are coiled around the tube supports above the fastener intake system 103, the fastener sorting system 103, and the lane interchanger system 110. This configuration allows for very long lengths of fastener staging lane tubing to be stored in a relatively small footprint. In one or more embodiments, at least one of the fastener staging lanes is greater than 10 meters. In certain embodiments, the fastener staging system 105 comprises greater than 7 parallel fastener staging lanes 120. For example, the fastener staging system 105 could comprise greater than 11 parallel fastener staging lanes, greater than 15 parallel fastener staging lanes, greater than 23 parallel fastener staging lanes, or greater than 35 fastener staging lanes.

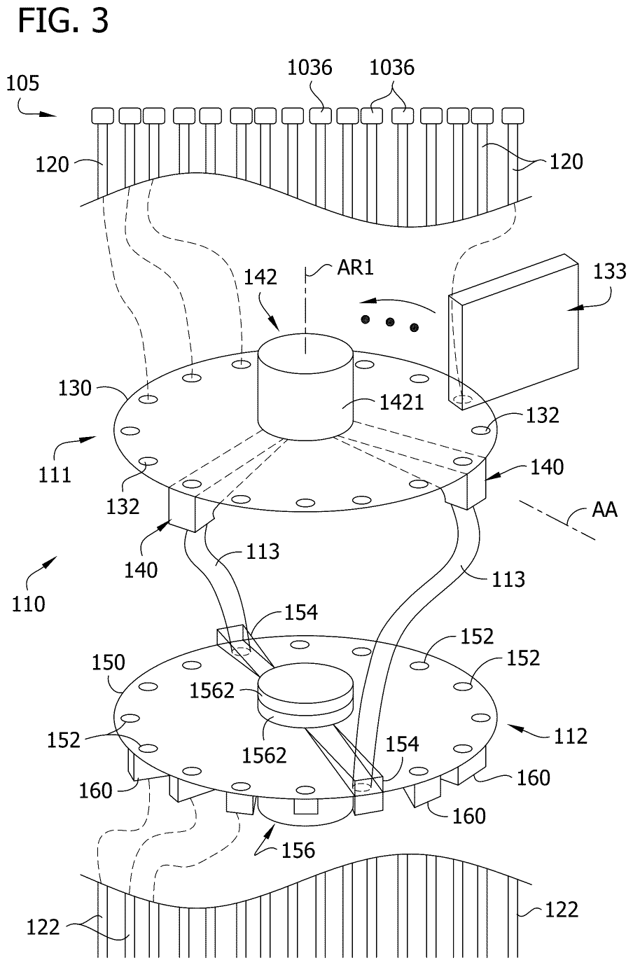

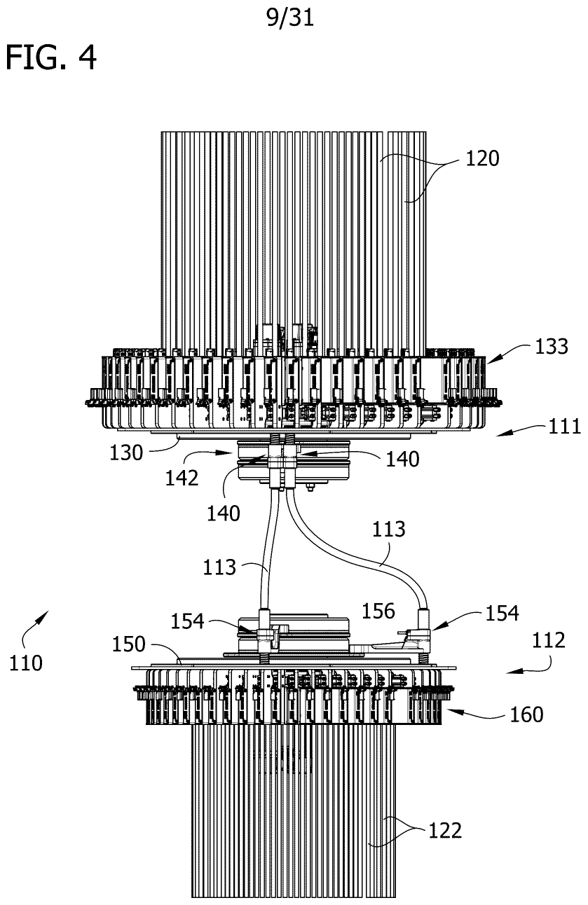

Referring now to FIGS. 3 and 4, the lane interchanger system is generally indicated at reference number 110. The lane interchanger system 110 connects to the fastener staging lanes 120 to a plurality of gun lanes 122. As explained above, each fastener staging lane 120 comprises a tube defining a passage for receiving a plurality of fasteners of one of a plurality of fastener types. Each gun lane 122 defines a passage having a proximal end portion connected to the lane interchanger and a distal end portion connected to one of the fastener installation guns 40. The passage of each gun lane 122 is sized and arranged such that fasteners of any of the plurality of fastener types are deliverable through the passage from the proximal end portion to the distal end portion to the respective fastener installation gun 40.

The lane interchanger system 110 is broadly configured to connect any of the fastener staging lanes 120 to any of the gun lanes 122 so that any type of faster can be delivered to any fastener installation gun 40 on command. The lane interchanger system 110 comprises a first lane changer 111, a second lane changer 112, and at least one lane change tube 113 having a first end and a second end. The first lane changer 111 is configured to selectively connect the first end of the lane change tube 113 to any of the fastener staging lanes 120. The second lane changer 112 is configured to selectively connect the second end of the lane change tube to any of the gun lanes 122. In the illustrated embodiment, there are a plurality of lane change tubes 113, specifically two lane change tubes, connecting the first lane changer 111 and the second lane changer 112 for double the throughput. In other embodiments, the lane interchanger system 110 can comprise other numbers of lane change tubes 113, depending on the throughput requirements for the system 30. Each lane change tube 113 has a first end and a second end. As explained more fully below, the first lane changer 111 is configured to selectively connect the first end of each lane change tube 113 to any of the fastener staging lanes 120, and the second lane changer 112 is configured to selectively connect the second end of each lane change tube 113 to any of the gun lanes 122.

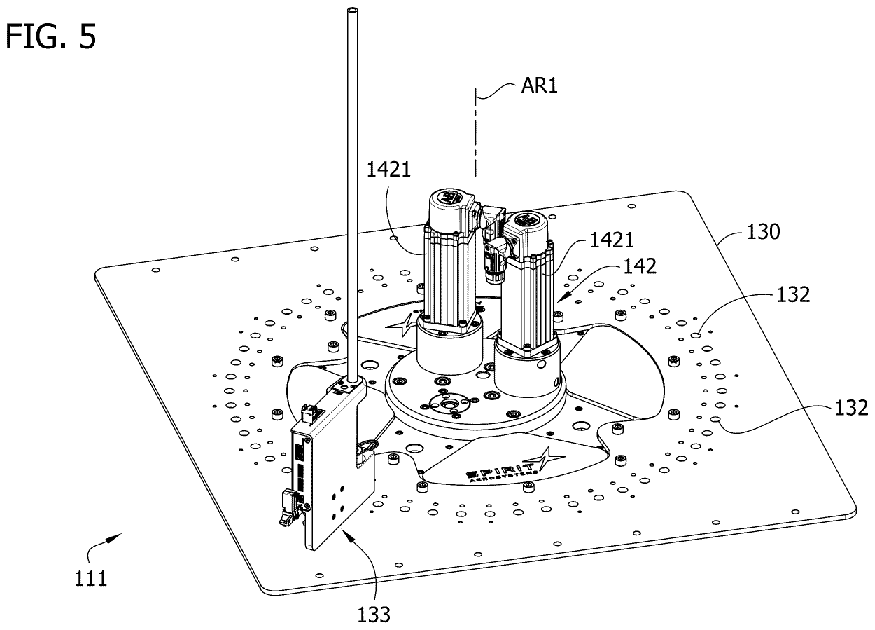

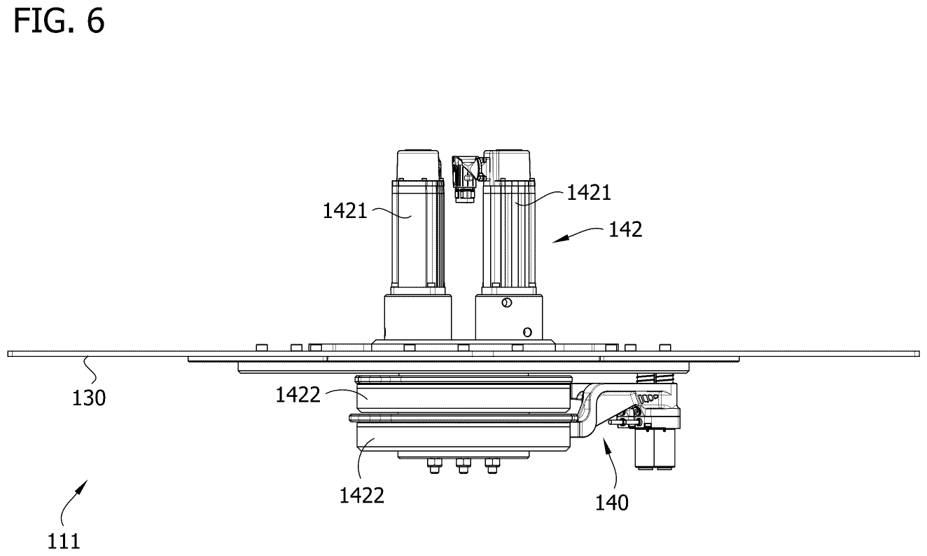

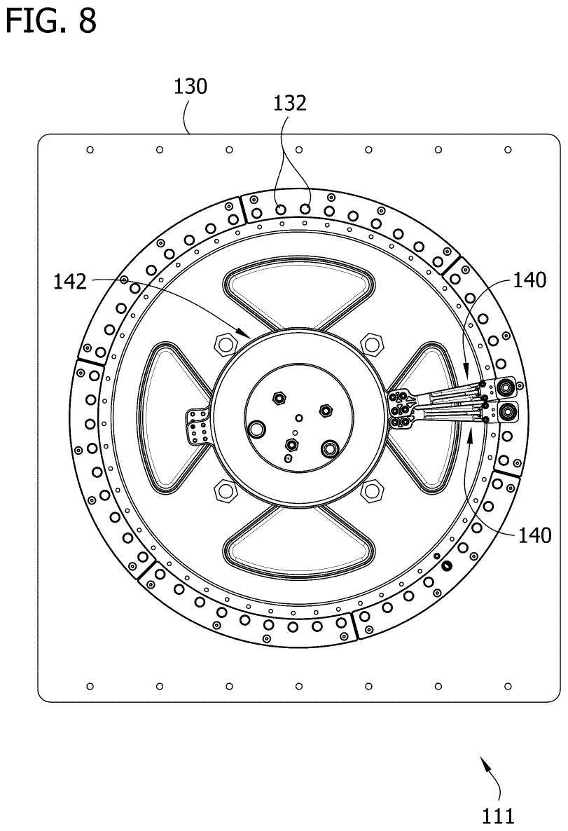

Referring to FIGS. 3-8, the first lane changer 111 broadly comprises a manifold 130 (sometimes called a ‘first lane changer manifold’) having a plurality of orifices 132 (sometimes called ‘first lane changer orifices’) spaced apart circumferentially about an axis of rotation AR1 (e.g., the first lane changer can comprise at least 12 orifices). Each orifice 132 is operatively connected to a respective one of the fastener staging lanes 120, as is indicated schematically in FIG. 3. More specifically, the lane interchange system 110 comprises a plurality of fastener escapement apparatuses 133 that operatively connect each orifice 132 to a respective fastener staging lane 120, as will be described in further detail below.

The first lane changer 111 further comprising at least one lane changer arm 140 (sometimes called a ‘first lane changer arm’ and a driver 142 (sometimes called a ‘first lane changer driver’) configured to selectively rotate each lane changer arm about the first axis of rotation AR1 to operatively align the lane changer arm with each of the plurality of orifices 132. In the illustrated embodiment, the first lane changer 111 comprises two lane changer arms 140, one for each lane change tube 113. The driver 142 is configured to independently rotate each lane changer arm 140 about the first axis of rotation AR1 to selectively align the first end of the lane change tube 113 to each of the plurality of orifices 132. As will be explained in further detail below, each lane changer arm 140 is configured such that fasteners of any fastener type are passable from the respective orifice 132 through the arm into the first end of the lane change tube 113. In an exemplary embodiment, each arm 140 is capable of boosting the fastener along the lane change tube 113 so that the fastener quickly advances from the first lane changer 111 to the second lane changer 112. An exemplary in-arm mechanism for boosting fasteners along the lane change tube is described in greater detail below.

In the illustrated lane interchanger system 110, the first lane changer is oriented so that the modular escapement mechanisms 133 are above the manifold 130, and the lane change changer arms 140 are below the manifold. A stator portion of the driver 142 containing one or more motors 1421 is positioned above the manifold 130. In the illustrated embodiment a plurality of driver rotors 1422 are stacked below the manifold. Each lane changer arm 140 is secured to a respective rotor 1422.

Referring to FIGS. 3 and 4, the second lane changer 112 is similar to the first lane changer 111 but is positioned below the first lane changer in an inverted orientation. The second lane changer 112 comprises a manifold 150 (sometimes called a “second lane changer manifold”) defining a plurality of orifices 152 (sometimes called “second lane changer orifices”) spaced apart circumferentially about a second axis of rotation AR2. In certain embodiments, the lane interchanger system 110 is arranged so that the first and second axes of rotation AR1, AR2 are coaxial, but this is not strictly required.

Each orifice 152 is configured to connect to a respective gun lane 122. More specifically, the illustrated lane interchanger system comprises a plurality of fastener boosters 160 below the manifold 150 that connect the orifices 152 to the gun lanes 162. In an exemplary embodiment, each fastener booster 160 is configured to detect when a fastener passes through the respective second lane changer orifice 152 and open a pneumatic valve to release a burst of pressurized air into the proximal end portion of the gun lane that drives the fastener quickly to the fastener installation gun 40 at the distal end portion of the gun lane 122.

The second lane changer 112 further comprises one or more lane changer arms 154 (sometimes called “second lane changer arms”) and a driver 156 (sometimes called a “second lane changer driver”) configured to selectively rotate each second lane changer arm independently about the second axis of rotation AR2 to operatively align the second lane changer arm with each of the plurality of second lane changer openings 152. In the illustrated embodiment, there are two lane changer arms 154 for the two lane change tubes 113. The lane changer arms 154 are located above the second manifold 150. The driver 156 has the essentially the same components as the driver 142 of the first lane changer 111 but the opposite orientation. Its driver motors 1561 are positioned below the manifold 150, and the rotors 1562 to which the lane changer arms 154 attach are above the manifold.

Referring to FIGS. 1A, 3, and 4, the lane interchanger system 110 is operatively connected to the system controller 42 so that the system controller can direct the lane interchanger system 110 to selectively connect any of the plurality of fastener staging lanes 120 to any of the plurality of gun lanes. When the system 30 is in use, the system controller 42 is configured to receive requests for fastener of specified fastener types from the fastener installation guns 40. In exemplary embodiment, such requests are made automatically when the user mates the fastener installation gun 40 with one of the openings 48 that is ready for receiving a fastener and the reader mechanism 401 reads the machine-readable element 50 for the opening. In response each request, the system controller 42 is configured to adjust the first lane changer 111 to selectively connect the first end of the lane change tube 113 to the fastener staging lane 120 containing the specified fastener type and adjust the second lane changer 112 to connect the second end of the lane change tube to the gun lane 122 operatively connected to the requesting one of the fastener installation guns 40. More specifically, the system controller 42 directs the first lane changer driver 142 to drive the first available lane changer arm 140 to the rotational position at which the lane changer arm aligns with the orifice 132 that is connected to a fastener staging lane 120 containing fasteners of the requested type. At the same time, the system controller directs the second lane changer driver 156 to drive lane changer arm 154 attached to same lane change tube 113 to the rotational position at which the lane changer arm aligns with the orifice 152 that is connected to the gun lane 122 terminated by the requesting fastener installation gun 40. In this way, the lane change tube 113 connecting the first lane changer arm 140 and the second lane changer arm 154 that have been rotated operatively connects the fastener staging lane 120 containing the specified fastener type to the gun lane for the requesting fastener installation gun 40 so that a fastener of the specified type is deliverable through the lane interchanger system 110 to the requesting fastener installation gun.

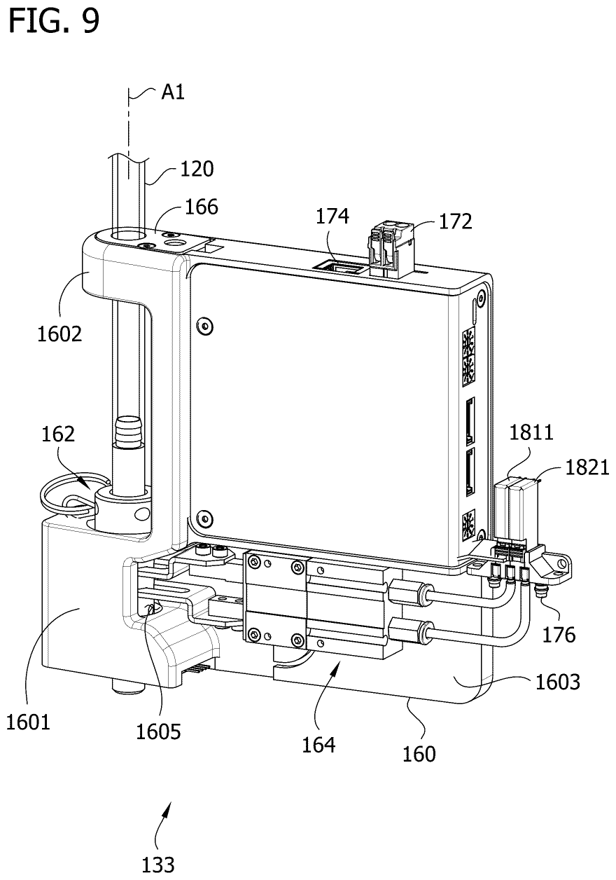

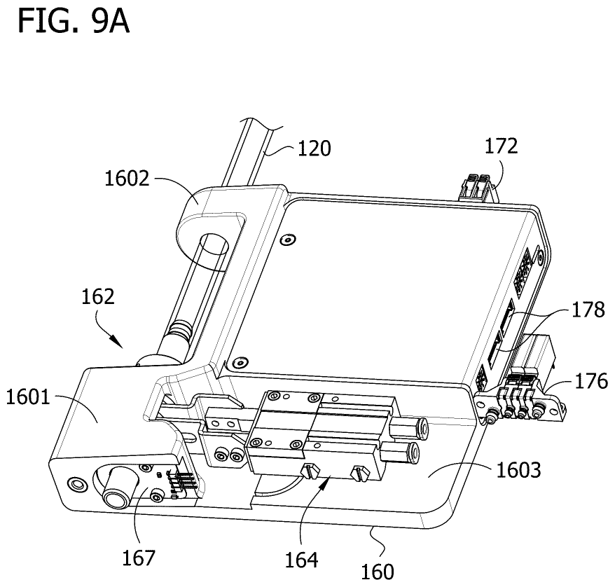

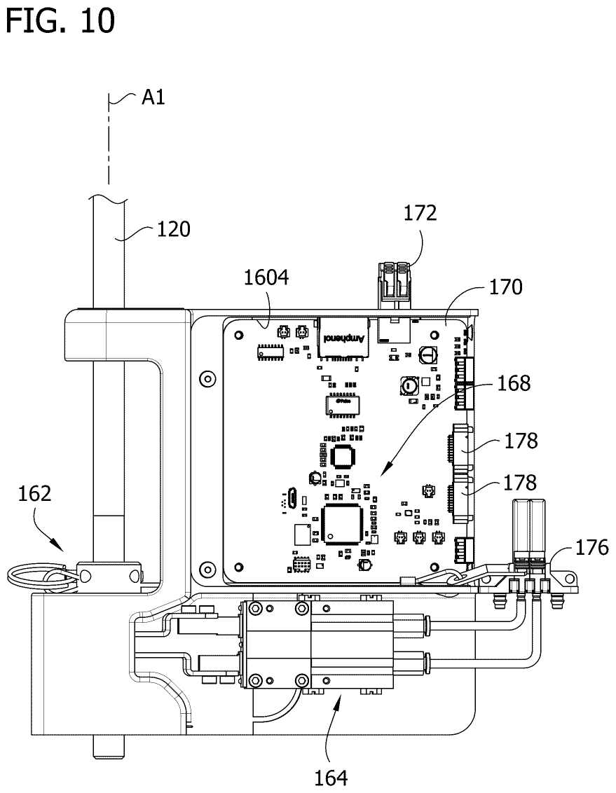

Referring to FIGS. 9 and 10, an exemplary embodiment of the fastener escapement apparatus 133 is shown. As explained above, the fastener escapement apparatuses 133 are broadly configured to connect each fastener staging lane 120 to the lane interchanger system 110. More specifically, each fastener escapement apparatus 133 couples to a respective fastener staging lane 120 and a respective orifice 132 of the first lane changer 111. In general, each fastener escapement apparatus 133 is configured to be selectively actuated to deliver fasteners one-at-a-time from the respective fastener staging lane 120 to the lane interchanger system, more specifically, into the respective orifice 132.

The fastener escapement apparatus 133 broadly comprises chassis 160 that supports an interchangeable fastener cartridge 162, an escapement actuator 164, and related electronics. The chassis 162 is configured to be mounted on a lane interchanger system 110 so that the fastener cartridge 162 fits into one of the orifices 132 in the manifold 130.

In the illustrated embodiment, the chassis 160 has a cartridge receptacle 1601 for receiving the interchangeable fastener cartridge 162. The cartridge receptacle 1601 has open top and bottom ends so that the upper and lower ends of the interchangeable fastener cartridge 162 are exposed for connection to a fastener staging lane 120 and first lane changer orifice 132, respectively.

The chassis 160 also comprises a lane guide 1602 above the cartridge receptacle 1601. Suitably, the lane guide 1602 and the cartridge receptacle 1601 are centered along a common axis A1 so that the downstream end portion of the fastener staging lane 120 can be inserted through the lane guide 1602 and fitted onto the interchangeable fastener cartridge 162 received in the cartridge receptacle. The cartridge receptacle 1601 and the lane guide 1602 are located along a side margin of the chassis 160 so that, when the fastener escapement apparatus 133 is coupled to the orifice, the remainder of the chassis 160 may extend radially outward in relation to the first axis A1.

The fastener escapement apparatus 133 comprises an upstream fastener sensor 166 mounted on the lane guide 1602 and a downstream fastener sensor 167 mounted on the lower end portion of the cartridge receptacle 1602. The upstream fastener sensor 166 is configured to detect the presence of a fastener in the respective fastener staging lane 120 adjacent to the fastener escapement apparatus 133 and to output a signal to the system controller 42 when no fastener is detected. The system controller 42 is configured to receive the signal from any upstream fastener sensor 166 indicating no fastener detected, and in response, to actuate the respective booster 1036 for the respective fastener staging lane 120 to advance fasteners along the respective fastener staging lane. The downstream fastener sensor 167 is configured to detect delivery of a fastener from the fastener escapement apparatus 133 and signal the system controller 42. The system controller 42 may use the signal from the downstream fastener sensor 167 as a trigger to actuate the arm-integrated booster of the first lane changer arm 140 to which the fastener is delivered (discussed in greater detail below).

To the side of the cartridge receptacle 1601, the chassis 160 comprises an actuator mounting compartment 1603. The escapement actuator 164 is mounted on the chassis 160 in the actuator mounting compartment 1603. Suitably, the chassis 160 defines an opening 1605 between the actuator mounting compartment 1603 and the cartridge receptacle 1601 through which the escapement actuator 164 can interface with the interchangeable fastener cartridge 162.

Above the actuator mounting compartment 1603, the chassis 160 comprises an electronics compartment 1604 (FIG. 10). A local controller 168 is mounted on a printed circuit board 170 in the electronics compartment 1604. Each local controller 168 communicates with the system controller 42 and is configured to control the escapement actuator 164 to conduct a single-fastener discharge routine whereby the fastener escapement apparatus 133 discharges one fastener to the lane interchanger system 110 when directed by the system controller.

In the illustrated embodiment, the fastener escapement apparatus 133 comprises a single power input 172, a single system controller input 174, and two daisy chain ports 178 in electrical communication with the printed circuit board 170. The daisy chain ports 178 can be used to daisy chain a plurality of fastener escapement apparatuses 133 together instead of separately connecting dedicated power and signal lines to the power and controller inputs 172, 174 of every fastener escapement apparatus 133. Those skilled in the art will appreciate that this reduces cabling and allows for a more organized fastener feeding system cabinet 100. A pressurized air input 176 is supported on the chassis 160 to allow for pneumatic actuation of the escapement actuator 164.

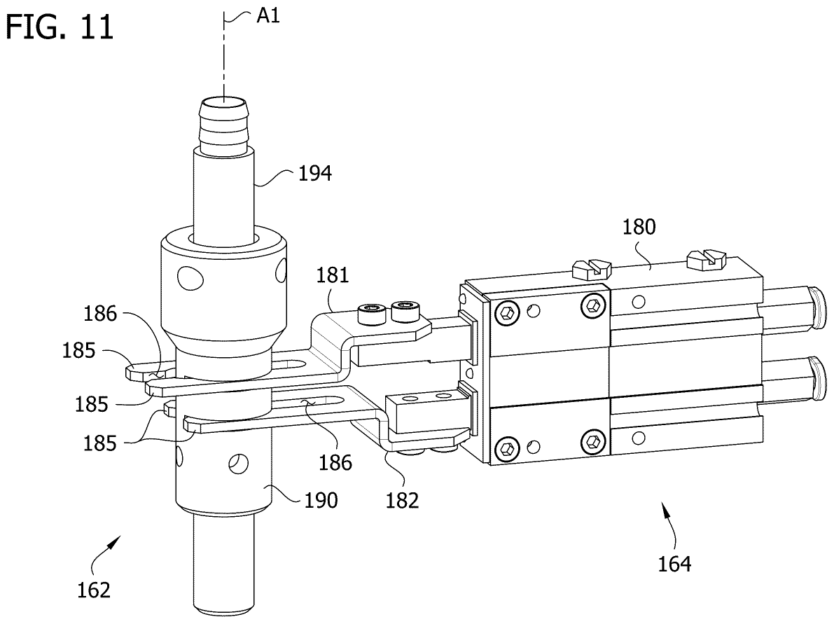

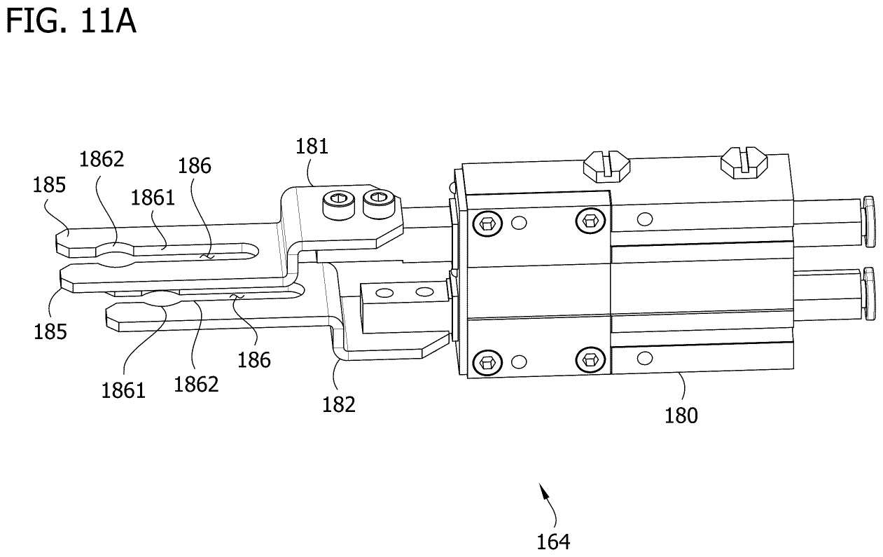

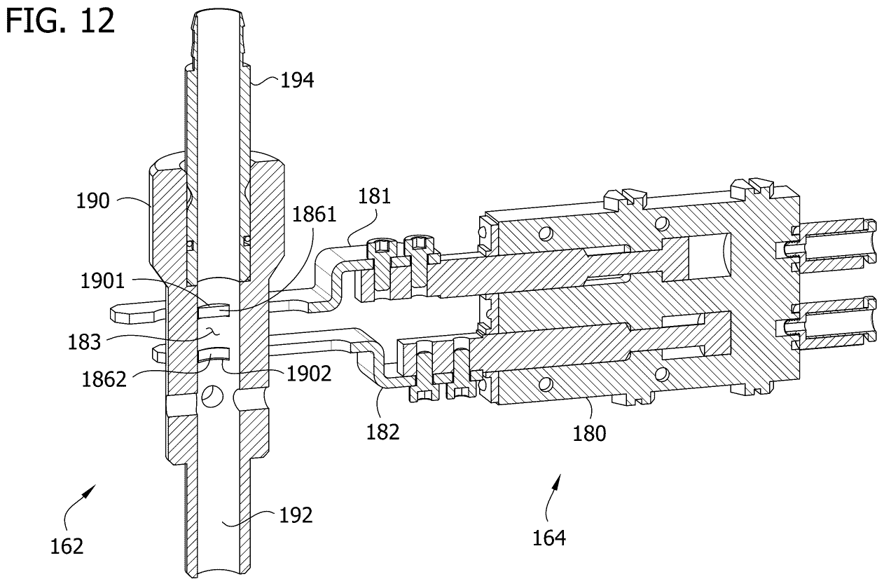

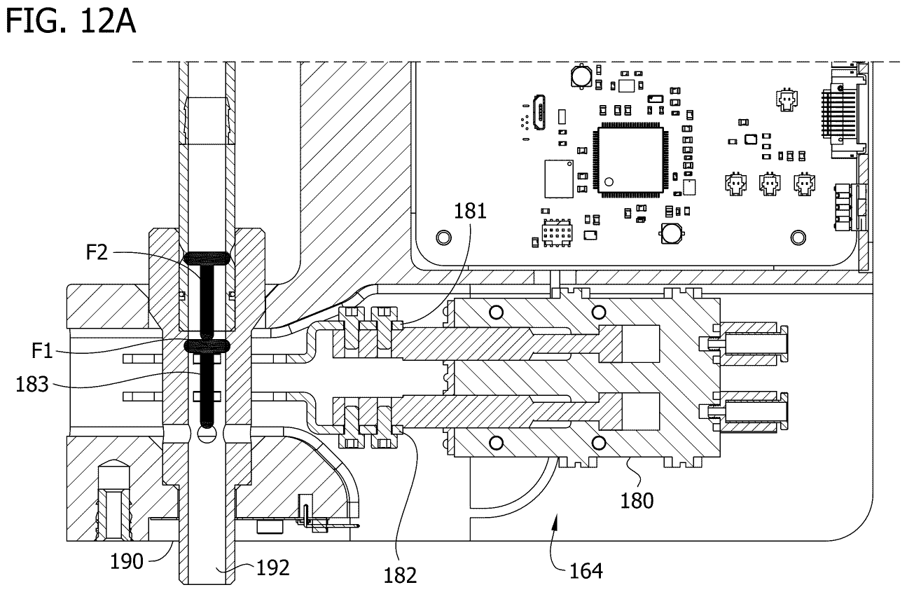

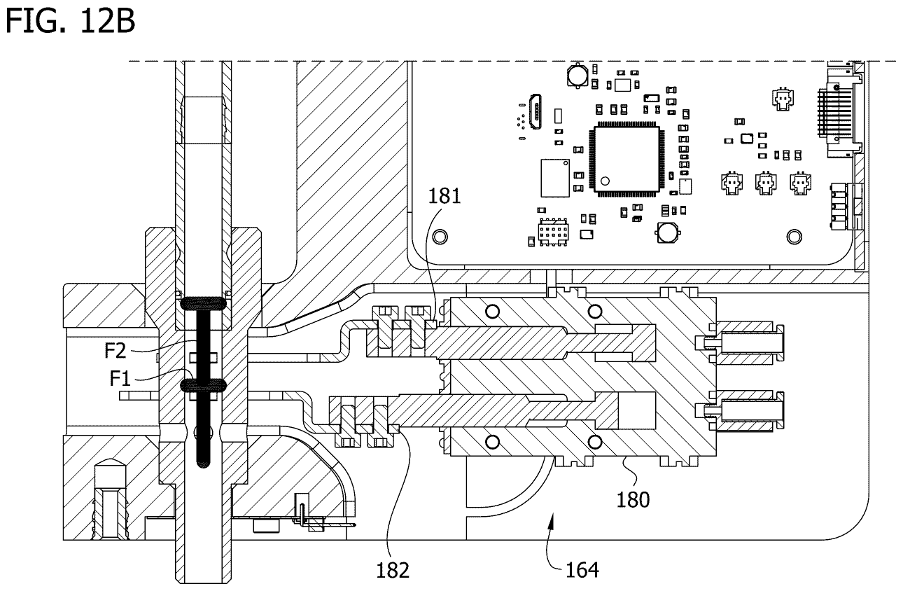

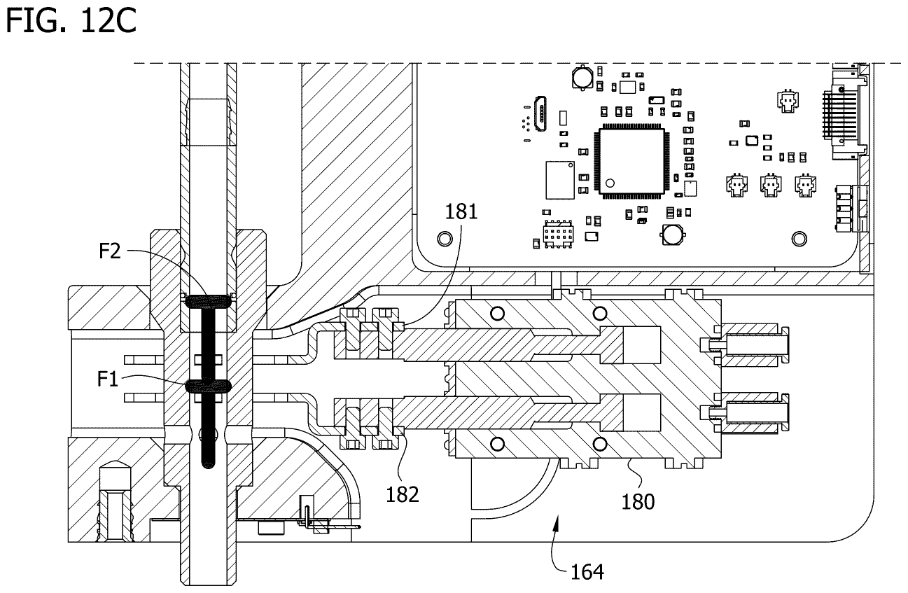

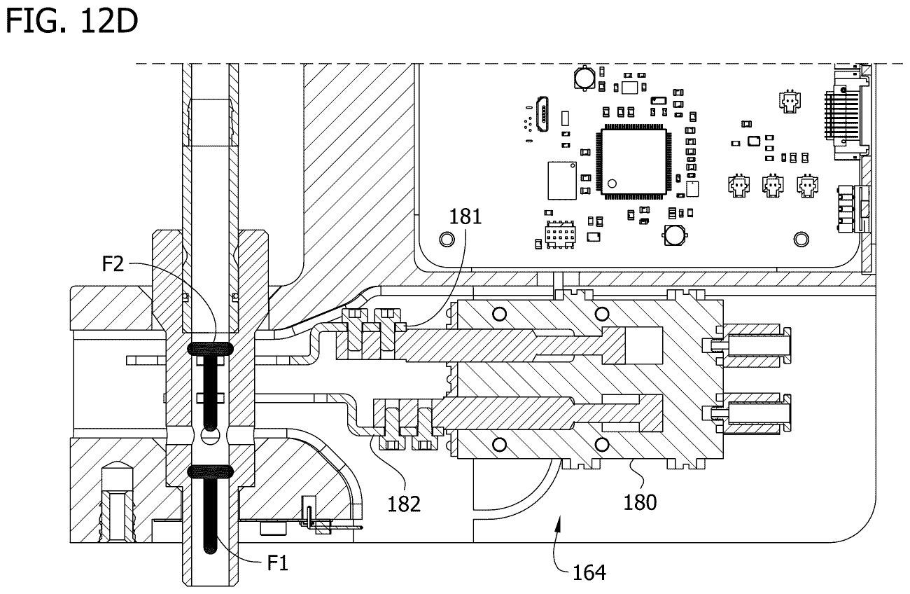

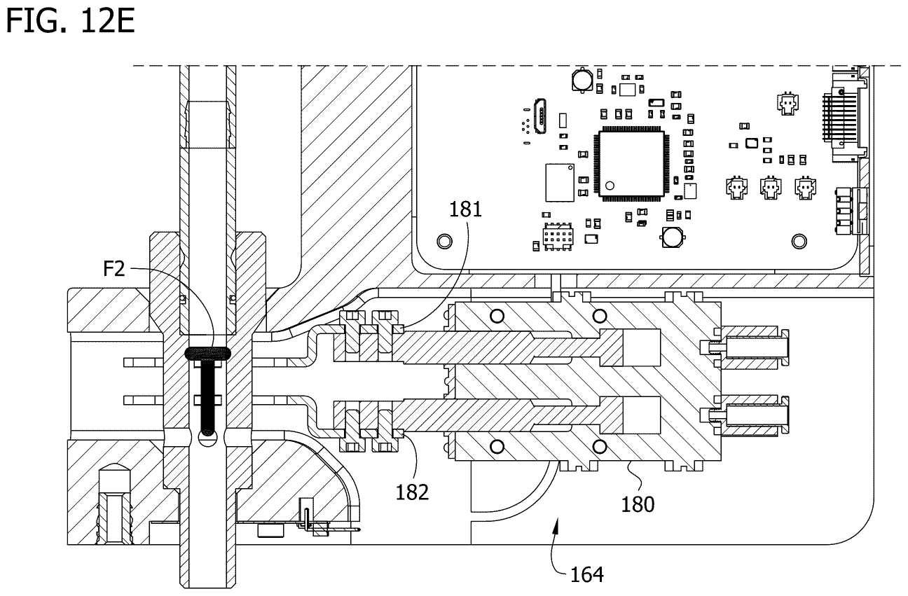

Referring to FIGS. 11 and 12, the escapement actuator 164 comprises a pneumatic piston device 180 that operates first and second fingers 181, 182. The first and second fingers 181, 182 are spaced apart heightwise such that a fastener space 183 is located between the two fingers. The pneumatic piston device 180 is configured to independently adjust the first and second fingers 181, 182 between a respective blocking position and a respective release position. The pneumatic piston device 180 is controlled by two solenoid valves 1811, 1821 in fluid communication with the air input 176. The local controller 168 is configured to selectively actuate a first solenoid valve 1811 to move the first finger 181 between the respective blocking position and the respective release position and actuate the second solenoid valve 1821 to move the second finger 182 between the respective blocking position and the respective release position. In the illustrated embodiment, the blocking position is an extended position of the respective finger 181, 182 and the release position is a retracted position of the respective finger. For example, in FIG. 12, it can be seen that the first finger 181 is extended and is positioned to block passage of a fastener through the interchangeable fastener cartridge, whereas the second finger 182 is retracted and positioned to allow passage of a fastener through the interchangeable fastener cartridge.

Referring to FIG. 11A, each finger 181, 182 has a split distal end portion forming two prongs 185 separated by a channel 186. The channel 186 includes a narrow section 1861 and a wide section 1862. As can be seen in FIG. 12, when one of the fingers 181, 182 is extended to the blocking position, the prongs 185 are positioned so that the narrow section 1861 of the channel 186 is in the interior of the interchangeable fastener cartridge 162. In this position, the prongs 185 block passage of a fastener through the interchangeable fastener cartridge 162. When a finger is retracted to the release position, the prongs 185 are positioned so that the wide section 1862 of the channel 186 is aligned with the interior of the interchangeable fastener cartridge 162. In this position, a fastener in the interchangeable fastener cartridge 162 is passable through the wide section 1862 of the channel 186.

Each interchangeable fastener cartridge 162 comprises a cartridge body 190 having an upstream end portion, a downstream end portion, and fastener passage 192 extending along the axis A1 from the upstream end portion through the downstream end portion. The cartridge body 190 comprises an annular wall surrounding the fastener passage 192 along the axis A1. Generally, the upstream end portion of the cartridge body 190 is configured to connect to a fastener staging lane 120 of the fastener feeding system 38 such that fasteners from the fastener staging lane are deliverable into the fastener passage 192 through the upstream end portion, and the downstream end portion of the cartridge body is configured to operatively couple to the lane interchanger system 110 when the chassis 160 is mounted on the lane interchanger system such that fasteners are deliverable from the fastener passage to the lane interchanger system through the downstream end portion. In the illustrated embodiment, the downstream end portion of the cartridge body 190 is sized and arranged for seating in one of the first lane changer orifices 132. A tube fitting 194 (e.g., a barbed nipple) for connecting to the fastener staging lane 120 is seated in the upstream end portion of the cartridge body 190.

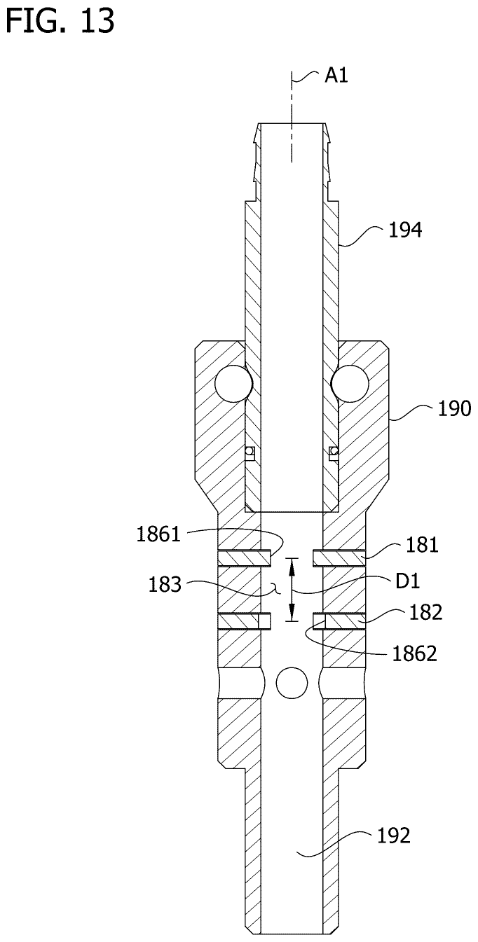

The cartridge body 190 defines a first finger opening 1901 extending through the wall of the cartridge body for slidably accepting the first finger 181 of the respective escapement actuator 164. The cartridge body 190 further defines a second finger opening 1902 that opens through the wall of cartridge body for slidably accepting the second finger 182 of the respective escapement actuator 164. The first and second finger openings 1901, 1902 are spaced apart along the axis A1 by a distance D1 (FIG. 13) corresponding to the size of the fastener space 183 between the fingers 181, 182. In the illustrated embodiment, each finger opening 1901, 1902 is made up of two parallel slots on diametrically opposite sides of the cartridge body 190 for accepting the two prongs 185 of the respective finger 181, 182.

The distance D1 creates a fastener space 183 that is suitable for receiving the head of a fastener between the two fingers 181, 182. When either finger 181, 182 is in a blocking position, the shank of the fastener will pass through the narrow section 1861 of the channel 186 and the head of the fastener will catch on the prongs 185, thereby blocking passage of the fastener through the fastener passage. When the head of the fastener is resting on the prongs 185 and the respective finger 181, 182 moves from the blocking position to the release position, the head of the fastener will pass through the wide section 1862 of the channel 186.

During use of the system 30, the system controller 42 is configured to receive requests for fasteners of specified fastener types from the fastener installation guns 40. In exemplary embodiment, such requests are made automatically when the user mates the fastener installation gun 40 with one of the openings 48 that is ready for receiving a fastener and the reader mechanism 401 reads the machine-readable element 50 for the opening. In response to each request, the system controller 42 is configured to adjust the lane interchanger system in the manner described above and then signal the local controller 168 of the fastener escapement apparatus 133 for the fastener staging lane in question to deliver a single fastener of the specified type to the lane interchanger system 110.

Referring to FIGS. 12A-12E, to control delivery of a single fastener to the lane interchanger system 110, the local controller 162 is configured to conduct single-fastener discharge routine in which it actuates the solenoid valves 1811, 1821 to sequentially move the fingers 181, 182 between the blocking and release positions in order to deliver one fastener to the lane interchanger system 110. Initially, both fingers 181, 182 are in the blocking position (FIG. 12A). As shown in FIG. 12B, the local controller 162 actuates the solenoid valve 1811 to adjust the first finger 181 from the blocking position to the release position to advance a first fastener F1. The first fastener F1 moves downward until the head catches on the second finger 182 (FIG. 12B). In this position, the head of the first fastener F1 rests on the prongs 184 of the second finger 182 with the shank extending through the narrow section 1861 of the channel 186. The head of the first fastener is received in the fastener space 183 between the first finger and the second finger 182. The tip of the second fastener F2 is supported on the head of the first fastener. (FIGS. 12A-12B).

Then, as shown in FIG. 12C, the local controller 168 actuates the solenoid valve 1811 to adjust the first finger 181 from the release position to the blocking position. This positions the first finger 181 so that it will block a second fastener F2 from advancing to the fastener space 183 once the first fastener F1 is dropped below the second finger 182.

Then, as shown in FIG. 12D, the local controller 168 actuates the solenoid valve 1821 to adjust the second finger 182 from the blocking position to the release position to release the first fastener F1 from the fastener space 183 to the lane interchanger system 110. The first finger 181 (which is in the blocking position) catches the head of the second fastener F2 as the second fastener falls.

Finally, as shown in FIG. 12E, the local controller 168 actuates the solenoid valve 1821 to adjust the second finger 182 from the release position to the blocking position, which readies the escapement actuator 164 for conducting a subsequent routine to deliver the second fastener F2.

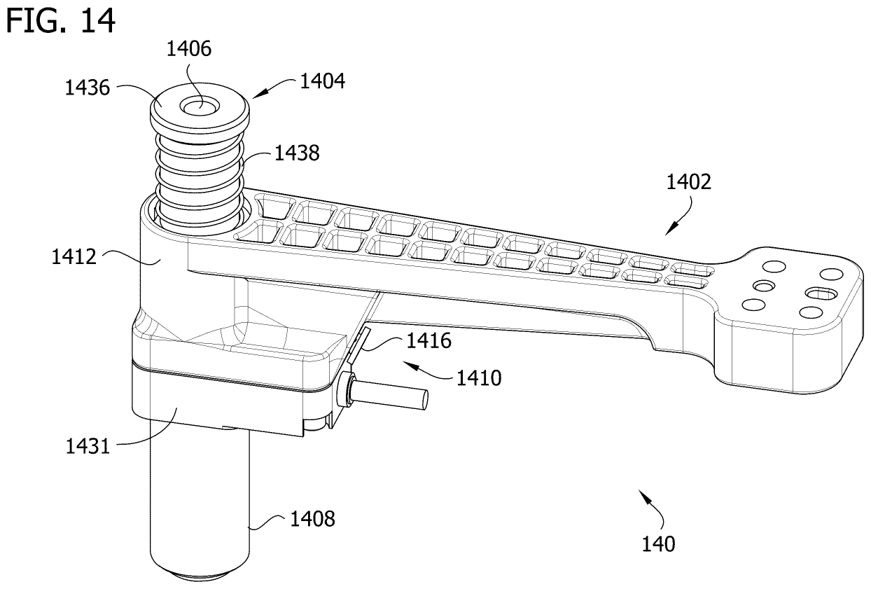

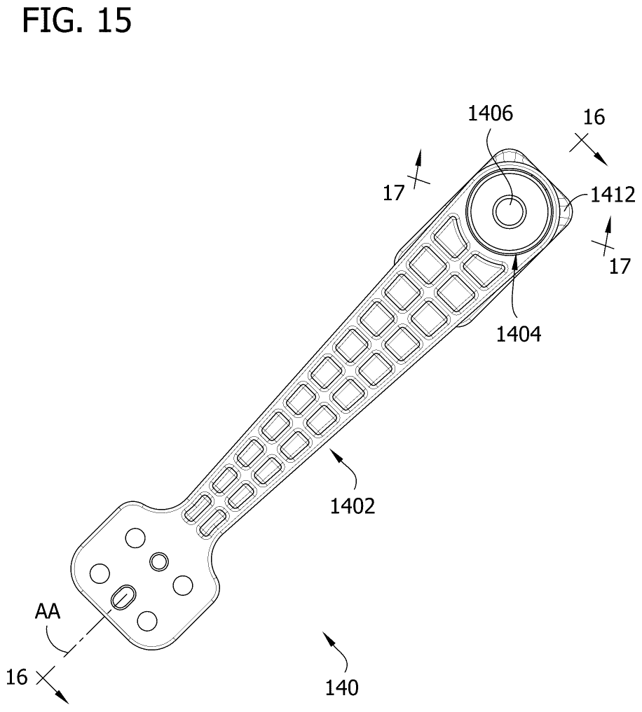

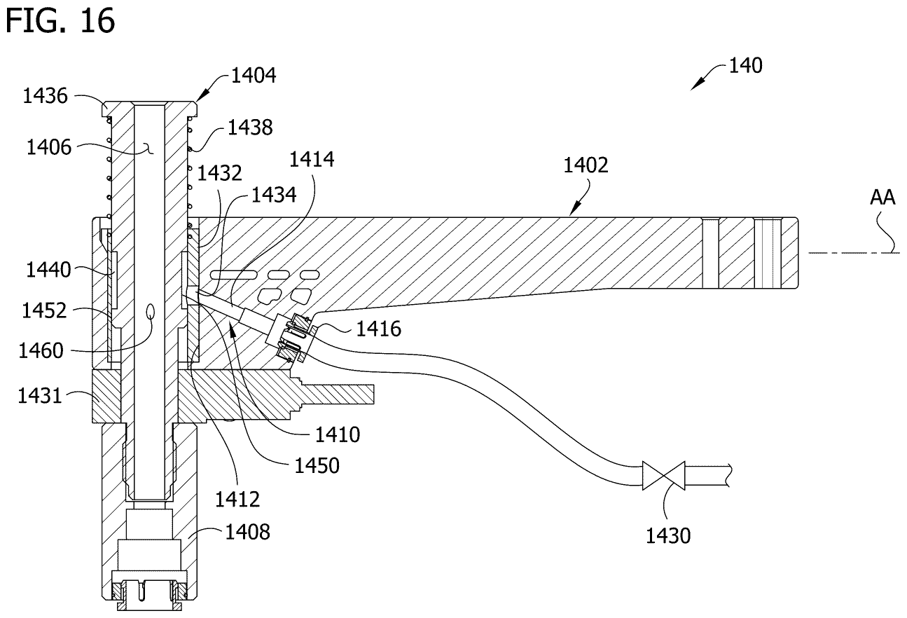

Referring now to FIGS. 14-18, an exemplary lane changer arm 140 for the first lane changer 111 of the lane interchanger system 110 is shown in greater detail. Although FIGS. 14-18 depict one lane changer arm 140, it will be understood that, in lane changers 111 comprising more than one arm, each arm can have essentially the same components and features. The lane changer arm 140 broadly comprises an arm body 1402 and a fastener guide 1404 received in the arm body for movement with the arm body in relation to the remainder of the lane changer 111. The lane changer arm 140 further comprises a tube connection fitting 1408 on the fastener guide 1404 for connecting the fastener lumen 1406 to the lane change tube 113 of the lane interchanger system 110. The fastener guide 1404 defines a fastener lumen 1406 through which a fastener of any of the plurality of fastener types contained in the fastener staging lanes 120 is passable to the lane change tube 113 of the lane interchanger system 110, and further through the second lane changer 112 to a gun lane 122. As will be explained in further detail below, the lane changer arm 140 comprises an integrated air booster 1410 configured to impart pressurized air into the fastener lumen 1406 when a fastener is delivered through the fastener lumen to boost the fastener along the lane change tube 113 toward the fastener installation gun 38. It is contemplated that the principles of the integrated air booster 1410 can be used with other fitting assemblies in a fastener feeding system without departing from the scope of the disclosure.

The arm body 1402 (broadly, the main body of a fitting assembly for use in a fastener feeding system) has an inner end portion and an outer end portion spaced apart along an arm axis AA oriented radially with respect to an axis of rotation AR1 of the first lane changer 111 (see FIG. 3). The inner end portion of the arm body 1402 is configured to connect to the first lane changer driver 142 (e.g., via a rotor 1422) such that the driver can rotate the arm body about the axis of rotation AR1. The outer end portion of the arm body 1402 defines a receiver 1412 and an air passage 1414 having a first end opening into the interior of the receiver and a second end opening externally through the arm body. A pneumatic fitting 1416 is coupled to the second end of the air passage 1414. The pneumatic fitting 1416 on the arm body 1402 connects the lane changer arm 140 to a source of pressurized air (not shown).

Each lane changer arm 140 of a multi-arm lane changer 111 can be connected to a pressurized air source by a respective, independently controllable control valve 1430. In one or more embodiments, the control valve 1430 is controlled by the system controller 42 (see FIG. 1A). In the illustrated embodiment, the lane changer arm 140 further comprises a fastener sensor 1431 (e.g., an inductive sensor) in communication with the controller. The fastener sensor 1431 is configured to detect when a fastener passes through the fastener lumen 1406. In response, the fastener sensor outputs a signal to the system controller 42. In certain embodiments, the system controller 42 is configured to respond to the signal by opening the control valve 130 to direct pressurized air into the integrated air booster 1410, whereby the air booster boosts the fastener along the lane change tube 113 of the lane interchanger system 110. This drives the fastener through the fastener interchanger 110 more quickly and reduces the time it takes to deliver the specified fastener to a fastener installation gun 40 upon request.

In the illustrated embodiment, the arm 1400 further comprises a sleeve 1432 (e.g., a sleeve formed from wear-resistant material such as Delrin® Polyoxymethylene acetal resin) seated in the receiver 1412 of the arm body 1402. The sleeve 1432 has an interior in which the fastener guide 1404 is received. The interior surface of the sleeve 1432 provides a bearing surface for the fastener guide 1404. The sleeve 1432 defines an opening 1434 in fluid communication with the air passage 1414. The opening 1434 extends through the entire wall thickness of the sleeve 1432 to provide fluid communication between the air passage 141 and the interior of the sleeve.

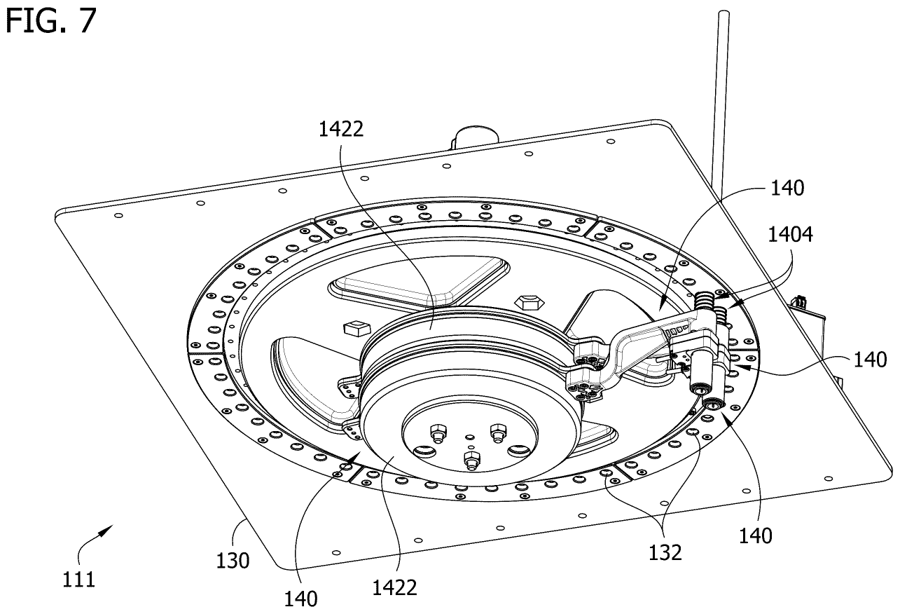

The fastener guide 1404 has a first (upper) end portion and a second (lower) end portion. The fastener lumen 1406 extends from the first end portion through the second end portion. When the arm 140 is installed in the lane changer 111, the first end portion of the fastener guide 1404 slidably engages the first lane changer manifold 130 (see FIG. 7).

In the illustrated embodiment, the first end portion of the fastener guide 1404 defines a flange 1436. A compression spring 1438 is positioned between the flange and the sleeve 1432. When the arms 140 are installed on the first lane changer 111 as shown in FIG. 7, the spring is loaded between the flange 1436 and the sleeve 1432 to yieldably bias the first end portion of the fastener guide 1404 upward in relation to the sleeve 1432 and the arm body 1402 into contact with the first lane changer manifold 130. The sleeve 1432 acts as a bearing slidably receiving the fastener guide 1404 in the interior of the sleeve.

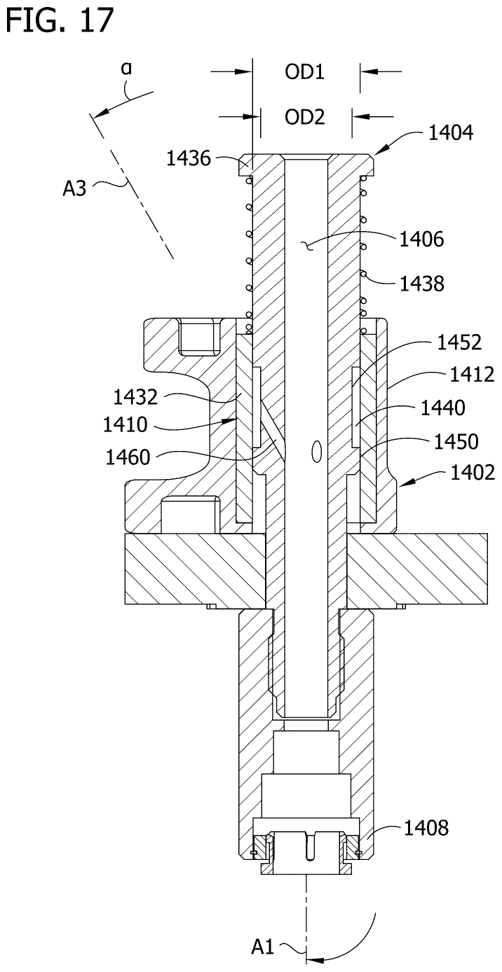

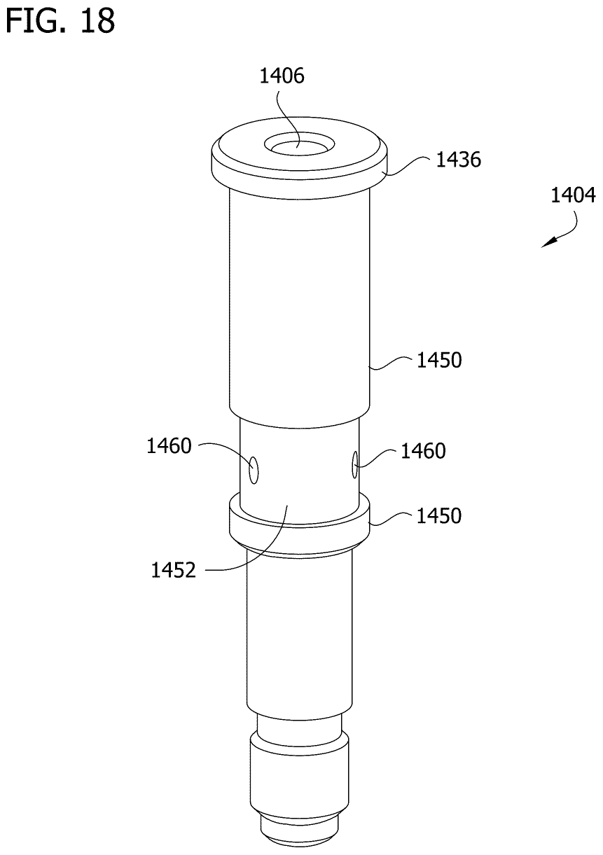

In the illustrated embodiment, the fastener guide 1404 is received in the interior of the sleeve 1432 such that the fastener guide and the sleeve define an annular booster cavity 1440 therebetween. The annular booster cavity 1440 is in fluid communication with the opening 1434 in the sleeve 1432. Hence, the opening 1434 in the sleeve 1432 provides fluid communication between the air passage 1414 in the arm body and the annular booster cavity 1440. The annular booster cavity 1440 extends 360° about the fastener guide 1404. As shown in FIG. 18, the fastener guide 1404 has a bearing portion 1450 and a cavity-defining portion 1452. The bearing portion 1450 has a first outer dimension OD1 (FIG. 17), and the cavity-defining portion 1452 has a second outer dimension OD2 less than the first outer dimension. The annular booster cavity 1440 is formed along the cavity-defining portion, and the bearing portion 1450 is made up of two segments on opposite ends of the cavity-defining portion 1452. The bearing portion slidably engages the sleeve 1432 and substantially seals the ends of the annular booster cavity 1440.

As explained above, the fastener guide 1404 defines a fastener lumen 1406 through which a fastener is passable from a fastener staging lane 120 toward a gun lane 122. The fastener guide 1404 further defines a booster lumen 1460 that opens into the fastener lumen 1406 to provide fluid communication between the annular booster cavity 1440 and the fastener lumen 1406. In the illustrated embodiment, the fastener guide 1404 comprises three booster lumens 1460 at circumferentially spaced apart locations (two of the booster lumens 1460 are visible in FIG. 18). Each booster lumen 1460 is configured so that pressurized air is passable from the annular booster cavity 1440 through the booster lumen into the fastener lumen 1406 to boost the fastener toward the fastener installation gun 40. The fastener lumen 1406 has a first axis A2 and each booster air lumen 1460 has a second axis A3. The second axis A3 is skewed with respect to the first axis A1. An included angle α between the first axis A2 and the second axis A3 on a downstream side of each booster lumen 1460 is in an inclusive range of from 135° to 160°.

The air passage 1414, the opening 1434, the annular booster cavity 1440, and the booster lumens 1460 form the integrated air booster 1410 configured to impart pressurized air into the fastener lumen 1406 when a fastener is delivered through the fastener lumen to boost the fastener toward a fastener installation gun 40. Pressurized air imparted into the air passage 1414 is delivered from the air passage 1414, through the opening 1434 in the sleeve 1432 into the annular booster cavity 1440, and from the annular booster cavity through the booster lumens 1460 into the fastener lumen 1406. Because of the skew angle α of the booster lumens 1460, the pressurized air enters at an angle such that the pressurized air in the fastener lumen boosts the fastener in the downstream direction (e.g., toward the second lane changer 112 and/or gun lane 122). In the typical case, the integrated air booster 1410 is actuated (e.g., by opening the control valve 1430) at the same time that the fastener escapement apparatus 133 is actuated to release the fastener. The booster 1410 creates a suction effect upstream that quickly draws the fastener downward from the escapement apparatus 133 and then imparts positive pressure behind the fastener head to impel the fastener further downstream, e.g., to hasten travel along the lane change tube 113. In some embodiments, the integrated air booster 1410 may be actuated (e.g., by opening control valve 1430) before the fastener passes the booster lumens 1460 (e.g., after actuation of the escapement actuator 164 or upon detection of a fastener by the downstream fastener sensor 167 of the escapement apparatus 133). It is believed that pressurized air entering the fastener lumen 1406 through the skewed booster lumens 1460 will create a Venturi effect in the fastener lumen 1406 that draws the fastener down through the fastener lumen. In this case, the control valve 1430 remains open so that the air booster 1410 continues to impel the fastener downstream after it crosses the booster lumens 1460.

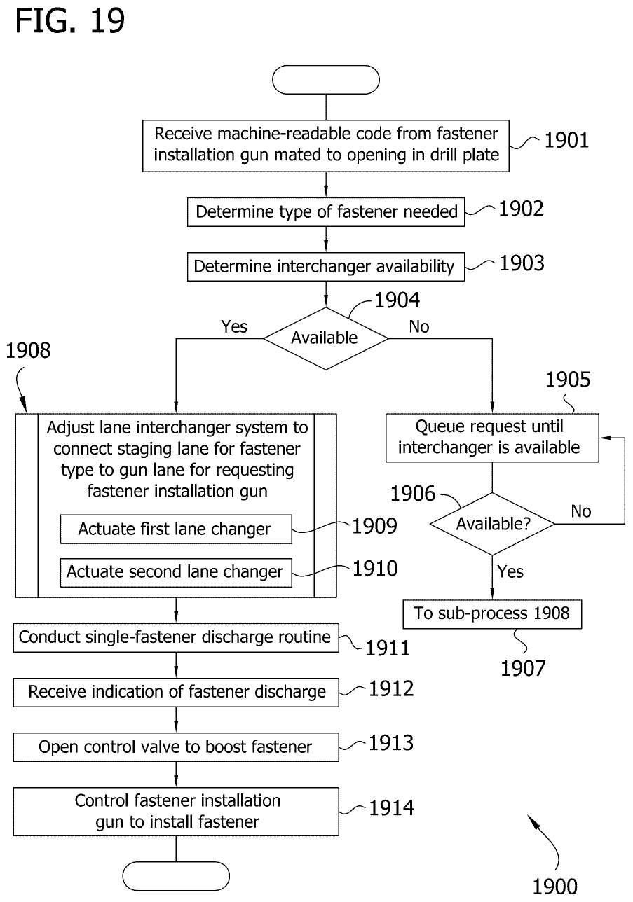

Referring to FIG. 19, an exemplary method of controlling the fastener feeding system for delivering fasteners to fastener installation guns 38 of the system 30 using the lane interchanger system 110, is generally indicated at reference number 1900 and will now be briefly described. The process 1900 is conducted by the system controller 42 and runs continuously to simultaneously handle fastener requests from a plurality of fastener installation guns 40. In FIGS. 1 and 1A, the system controller 42 is depicted as being a single-node controller. But it will be understood that this representation is but one possibility. The system controller 42 could include a plurality of discrete control modules operating on one or more control circuits (e.g., one or more control processors), at one physical location or at distributed locations on-premises or one or more remote locations. Control modules making up the system controller 42 depicted schematically in FIGS. 1 and 1A communicate with one another electronically so that they may interoperate to collectively carry out the process 1900 depicted in FIG. 19.

The process 1900 beings at step 1901 when the system controller 42 receives machine-readable code information from one of the fastener installation guns 40 that has been properly mated to an opening 48 in a drill plate 34. In the illustrated embodiment, upon receipt of the information in step 1901, the system controller 42 queries the system memory 54 to determine the type of fastener that is needed for the respective hole 48 (step 1902).

Next at step 1903, the system controller 42 determines whether the lane interchanger system 110 has immediate availability to deliver the required type of fastener to the requesting fastener installation gun 40. For example, the system controller 42 evaluates the positions of the lane changer arms 140, 154 and whether there is a current queue of requests to determine whether it is possible to adjust one pair of the lane changer arms 140, 154 to positions where that lane change tube 113 connecting them is positioned to connect the fastener staging lane 120 for the required fastener type to the gun lane 122 for the requesting fastener installation gun 40. If at decision point 1904, the system controller 42 determines there is no current availability, at step 1905, the system controller 42 queues the request until there is availability (decision point 1906), at which point the system controller 42 proceeds with sub-process 1908, described below.

If the lane interchanger system 110 is determined to be available in either decision point 1904 or decision point 1906, system controller 42 proceeds (see step 1907) and conducts a sub-process 1908 for adjusting the lane interchanger system to connect the fastener staging lane 120 for the requested fastener type to the gun lane 122 for the requesting fastener installation gun 40. The sub-process 1908 involves two steps 1909, 1910 that can be carried out in any order or simultaneously. At step 1909, the system controller 42 actuates the first lane changer 111 to position the first end of the lane change tube 113 in communication with a fastener staging lane 120 for fasteners of the requested fastener type. As explained above, actuating the first lane changer 111 comprises rotating a lane change arm 140 of the first lane changer 111 to align with an orifice 132 in a manifold 130 of the first lane changer 111 that is connected to the fastener staging lane 120 containing fasteners of the required fastener type. Step 1910 of sub-process 1908 comprises actuating the second lane changer 112 to adjust the second end of the same lane change tube 113 to be in communication with the gun lane 122 connected to the requesting fastener installation gun 40. As explained above, actuating the second lane changer 112 comprises rotating a lane change arm 154 of the second lane changer 112 to align with the orifice 152 in the manifold 150 of the second lane changer 112 that is connected to the gun lane 122 for the requesting fastener installation gun 40. It can be seen that the sub-process 1908 adjusts the lane interchanger system 110 so that one lane change tube 113 connects the fastener staging lane 120 containing the specified fastener type to the gun lane 122 for the requesting fastener installation gun 40 so that a fastener of the specified type is deliverable through the lane interchanger system 110 to the requesting fastener installation gun. In exemplary embodiments, it takes one second or less to complete sub-process 1908.

After actuating the first and second lane changers 111, 112 in sub-process 1908, a fastener is delivered from the fastener staging lane 120 through the lane change tube 113 and through the gun lane 122 to the requesting fastener installation gun 40 in accordance with steps 1911, 1912, and 1913. Initially, the system controller 42 directs the fastener escapement apparatus 133 for the fastener staging lane 122 to conduct the single-fastener discharge routine depicted in FIGS. 12A-12E and described above (step 1911). Subsequently, at step 1912, the system controller 42 receives an indication that the fastener has been discharged from a fastener sensor (e.g., the fastener sensor 1431 or 167). In step 1913, the system controller 42 opens the control valve 1430 to actuate the integrated air boost 1410 in the lane changer arm 140. This impels the fastener through the lane change tube 113 toward the requesting fastener installation gun 40. In some embodiments, another air booster 160 associated with the second lane changer 112 can further boost the fastener along the gun lane 122 to the requesting fastener installation gun 40 after the fastener passes through the second lane changer.

At step 1914, the system controller 42 controls the fastener installation gun 40 to install the fastener into the structure A at the opening 48 in the fastener plate 34. When no queuing is required, the entire process 1900 can be carried out in less than 3 seconds.

The inventors believe that the above-described fastener feeding system 38 provides benefits over the prior art. For example, the lane interchanger system 110 allows for feeding various types of fasteners to any of plurality of different fastener installation guns 40 quickly and automatically. The fastener interchanger system 110 can feed twelve or more different types of fasteners to twelve or more different fastener installation guns 40, and even in such systems with many types of fasteners and many different fastener installation guns, it will accurately deliver the requested fasteners to the requesting fastener installation guns 40 in less than 2 seconds.

The fastener escapement apparatuses 133 ensure that each type of fastener is consistently advanced along the fastener staging lane 120 to a ready position at which it is possible to discharge the fastener into the lane interchanger system 110 on command. Further, the fastener escapement apparatus 133 provides a reliable mechanism for delivering fasteners one-at-a-time into the fastener interchanger system 110. The fastener escapement apparatuses 133 are also easily reconfigurable (by exchanging the interchangeable fastener cartridge 162 and fingers 181, 182) to accommodate different types of fasteners in the same fastener staging lane 120.

The lane change arm 140 also contributes to the performance of the fastener feeding system 38 as a whole. The integrated air booster 1410 in the lane changer arm 140 advances the aims of the fastener feeding system 38 by increasing the speed with which each fastener flows through the fastener interchanger system 110. Integrating the air booster 1410 directly into the arm 140 that facilitates fastener staging lane selection increases the speed of delivery of fasteners through the fastener interchanger system 110 while preserving the ability of the fastener interchanger system 110 to selectively deliver many different types of fasteners to many different fastener installation guns.

Embodiments of the present disclosure may comprise a special purpose computer including a variety of computer hardware, as described in greater detail herein.

For purposes of illustration, programs and other executable program components may be shown as discrete blocks. It is recognized, however, that such programs and components reside at various times in different storage components of a computing device, and are executed by a data processor(s) of the device.

Although described in connection with an example computing system environment, embodiments of the aspects of the invention are operational with other special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the example operating environment. Examples of computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the present disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments may be implemented with processor-executable instructions. The processor-executable instructions may be organized into one or more processor-executable components or modules on a tangible processor readable storage medium. Also, embodiments may be implemented with any number and organization of such components or modules. For example, aspects of the present disclosure are not limited to the specific processor-executable instructions or the specific components or modules illustrated in the figures and described herein. Other embodiments may include different processor-executable instructions or components having more or less functionality than illustrated and described herein.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the invention.

When introducing elements of the invention or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

What is claimed is:

1. A fastener feeding system for selectively feeding a plurality of fastener types to a plurality of fastener installation guns, the fastener feeding system comprising:
a plurality of fastener staging lanes, each fastener staging lane comprising a passage configured for receiving a plurality of fasteners of one of the plurality of fastener types;
a plurality of gun lanes, each gun lane defining a passage having a proximal end portion and a distal end portion configured to operatively connect to one of the plurality of fastener installation guns, the passage of each gun lane being sized and arranged such that fasteners of any of the plurality of fastener types are deliverable through the passage from the proximal end portion to the distal end portion to the respective fastener installation gun;
a lane interchanger system, the lane interchanger system comprising a first lane changer, a second lane changer, and lane change tube having a first end and a second end, the first lane changer configured to selectively connect the first end of the lane change tube to any of the fastener staging lanes, the second lane changer configured to selectively connect the second end of the lane change tube to any of the gun lanes; and
a controller configured to receive a request for a fastener of a specified fastener type from one of the fastener installation guns, wherein in response to receiving the request, the controller is configured to adjust the first lane changer to selectively connect the first end of the lane change tube to the fastener staging lane containing the specified fastener type and adjust the second lane changer to connect the second end of the lane change tube to the gun lane operatively connected to said one of the fastener installation guns, whereby the lane change tube operatively connects said fastener staging lane containing the specified fastener type to said gun lane operatively connected said one of the fastener installation guns so that said fastener of the specified type is deliverable through the lane interchanger system to said one of the fastener installation guns.

2. The fastener feeding system of claim 1, wherein the lane change tube comprises a plurality of lane change tubes, each lane change tube having a first end and a second end, the first lane changer configured to selectively connect the first end of each lane change tube to any of the fastener staging lanes and the second lane changer configured to selectively connect the second end of each lane change tube to any of the gun lanes.

3. The fastener feeding system of claim 1, wherein the first lane changer comprises a manifold having a plurality of orifices, each orifice operatively connected to a respective one of the fastener staging lanes.

4. The fastener feeding system of claim 3, wherein the first lane changer further comprises an arm coupled to the first end of the lane change tube and a driver configured to rotate the arm about a first axis of rotation to selectively align the first end of the lane change tube to each of the plurality of orifices.

5. The fastener feeding system of claim 4, wherein the arm comprises a plurality of arms, the driver configured to rotate each of the plurality of the plurality of arms individually to selectively align the respective arm with each of the plurality of orifices.

6. The fastener feeding system of claim 5, wherein the plurality of orifices comprises at least 12 orifices.

7. The fastener feeding system of claim 3, wherein the plurality of orifices comprises at least 12 orifices.

8. The fastener feeding system of claim 1, wherein the second lane changer comprises a manifold having a plurality of orifices, each orifice operatively connected to a respective one of the gun lanes.

9. The fastener feeding system of claim 8, wherein the second lane changer further comprises an arm coupled to the second end of the lane change tube and a driver configured to rotate the arm about an axis of rotation to selectively align the second end of the lane change tube to each of the plurality of orifices.

10. The fastener feeding system of claim 9, wherein the arm comprises a plurality of arms, the driver configured to rotate each of the plurality of the plurality of arms individually to selectively align the respective arm with each of the plurality of orifices.

11. The fastener feeding system of claim 8, wherein the plurality of orifices comprises at least 12 orifices.

12. A lane interchanger system for selectively delivering fasteners from fastener staging lanes of a fastener feeding system to gun lanes of the fastener feeding system, the lane interchanger system comprising:
a first lane changer comprising a first lane changer manifold defining a plurality of first lane changer orifices spaced apart circumferentially about a first axis of rotation, each first lane changer orifice configured to connect to a respective fastener staging lane, the first lane changer further comprising a first lane changer arm and a first lane changer driver configured to selectively rotate the first lane changer arm about the first axis of rotation to operatively align the first lane changer arm with each of the plurality of first lane changer openings;
a second lane changer comprising a second lane changer manifold defining a plurality of second lane changer orifices spaced apart circumferentially about a second axis of rotation, each second lane changer orifice configured to connect to a respective gun lane, the second lane changer further comprising a second lane changer arm and a second lane changer driver configured to selectively rotate the second lane changer arm about the second axis of rotation to operatively align the second lane changer arm with each of the plurality of second lane changer openings; and
a lane change tube having a first end and a second end, the first end coupled to the first lane changer arm for movement with first lane changer arm about the first axis of rotation such that when the first lane changer arm is operatively aligned with one of the first lane changer openings the first end of the lane change tube is positioned for receiving a fastener delivered from the respective fastener staging lane, the second end coupled to the second lane changer arm such that when the second lane changer arm is operatively aligned with one of the second lane changer openings the second end of the lane change tube is positioned for delivering a fastener to the respective gun lane.

13. The lane interchanger system of claim 12, wherein the first lane changer arm comprises a plurality of first lane changer arms, the second lane changer arm comprises plurality of second lane changer arms, and the lane change tube comprises a plurality of lane change tubes.

14. The lane interchanger system of claim 13, wherein the first lane changer driver is configured to independently rotate each of the plurality of first lane changer arms about the first axis of rotation and the second lane changer driver is configured to independently rotate each of the plurality of second lane changer arms about the second axis of rotation.

15. The lane interchanger system of claim 12, wherein the second axis of rotation is coincident with the first axis of rotation.

16. The lane interchanger system of claim 12, wherein each of the first lane changer driver and the second lane changer driver comprises a servo motor.

17. A method of installing fasteners in a vehicle structure, the method comprising:
receiving a request for a first fastener of a first fastener type from a fastener installation gun;
in response to receiving the request, actuating a first lane changer to adjust a first end of a lane change tube to be in communication with a fastener staging lane containing fasteners of the first fastener type;
further in response to receiving the request, actuating a second lane changer to adjust the second end of the lane change tube to be in communication with a gun lane connected to said fastener installation gun;
after actuating the first and second lane changers, delivering a first fastener from the fastener staging lane through the lane change tube and through said gun lane to said fastener installation gun; and
installing the first fastener using said fastener installation gun.

18. The method of claim 17, wherein an entire duration from said receiving the request to receiving said fastener in said fastener installation gun is less than 2 seconds.

19. The method of claim 17, wherein said actuating the first lane changer comprises rotating an arm of the first lane changer to align with an orifice in a manifold of the first lane changer connected to said fastener staging lane containing fasteners of the first fastener type and wherein said actuating the second lane changer comprises rotating an arm of the second lane changer to align with an orifice in a manifold of the second lane changer connected to said gun lane connected to said fastener installation gun.

20. The method of claim 17, wherein said fastener installation gun is a first fastener installation gun and wherein the method further comprises:
receiving a second request for a second fastener of a second fastener type from a second fastener installation gun;
in response to receiving the second request, actuating the first lane changer to adjust the first end of a lane change tube to be in communication with another fastener staging lane containing fasteners of the second fastener type;
further in response to receiving the request, actuating the second lane changer to adjust the second end of the lane change tube to be in communication with a second gun lane connected to said second fastener installation gun;
after actuating the first and second lane changers, delivering a second fastener from the second fastener staging lane through the lane change tube and through said second gun lane to said second smart fastener installation gun; and
installing the second fastener using said smart fastener installation gun.
